(19) United States
(12) Patent Application Publication
(10) Pub. No.: US 2026/0050841 A1
(43) Pub. Date: Feb. 19, 2026

(54) LEARNING DEVICE, STATE INFERRING DEVICE, AND STATE MONITORING SYSTEM

(71) Applicant: Mitsubishi Electric Corporation, Tokyo (JP)

(72) Inventors: Yuki TANAKA, Tokyo (JP); Koji WAKIMOTO, Tokyo (JP); Takaaki NAKAMURA, Tokyo (JP); Miyu UEMURA, Tokyo (JP)

(73) Assignee: Mitsubishi Electric Corporation, Tokyo (JP)

(21) Appl. No.: 19/295,216

(22) Filed: Aug. 8, 2025

Related U.S. Application Data
(63) Continuation of application No. PCT/JP2023/005086, filed on Feb. 15, 2023.

(51) Int. Cl. G06N 20/20; G06V 10/22; G06V 10/776

(52) U.S. Cl. CPC G06N 20/20; G06V 10/22; G06V 10/776

(57) ABSTRACT

A learning device includes processing circuitry configured to: construct, on a basis of training data explainable by a plurality of explanatory variables and a first explanatory variable that is an explanatory variable designated from an outside and is one of the plurality of explanatory variables, a first regression model applicable to the training data and the first explanatory variable; select a second explanatory variable from among the plurality of explanatory variables, and to select, from the training data, a second explanatory variable with which target data regarded as varying on a basis of the constructed first regression model is separable from the training data; and construct, using training data after the target data is separated on a basis of the selected second explanatory variable and the first explanatory variable, a second regression model applicable to the training data and the first explanatory variable.

### CROSS REFERENCE TO RELATED APPLICATION

This application is a Continuation of PCT International Application No. PCT/JP2023/005086, filed on Feb. 15, 2023, which is hereby expressly incorporated by reference into the present application.

### TECHNICAL FIELD

The present disclosure relates to a learning device, a state inferring device, and a state monitoring system.

### BACKGROUND ART

In the manufacturing industry field, abnormality detection of equipment (hereinafter, also referred to as a “target device”) such as a plant and a rotary machine is performed using a learned model learned by machine learning. Here, abnormality of the target device is, for example, deterioration of the target device. Generally, it is more difficult to collect abnormal data from the target device than to collect normal data. Thus, in learning of the learned model, in many cases, a learning device performs unsupervised learning using only normal data collected from the target device as training data, and learns the model. In this case, an inferring device that infers the state of the target device calculates an abnormality indicating how much the state of the target device deviates from a normal state using the learned model. At this time, in the inferring device, a threshold for determining abnormality is set for the abnormality, and the target device is determined to be abnormal when the calculated abnormality exceeds the threshold. In relation to such an abnormality detection technique, for example, Non Patent Literature 1 and Non Patent Literature 2 describe an abnormality detection technique using a linear regression model and a Gaussian process regression model.

### CITATION LIST

### Non Patent Literatures

Non Patent Literature 1: Tsuyoshi Ide, “Introduction to Anomaly Detection Using Machine Learning”, Corona Publishing Co., Ltd., 2019
Non Patent Literature 2: Tsuyoshi Ide, “Abnormality Detection and Change Detection”, Corona Publishing Co., Ltd., 2018

### SUMMARY OF INVENTION

### Technical Problem

Non Patent Literature 1 and Non Patent Literature 2 describe an abnormality detection technique in a case where there is no variation in normal data learned by a learning device. On the other hand, a target device such as a plant and a rotary machine are less likely to continue to operate under constant operating conditions (for example, a certain operation pattern and motion pattern), and are often operated under various operating conditions. In this case, the normal data collected from the target device may vary depending on differences in the operating conditions. Note that the operating conditions of the target device are determined by a large number of pieces of control information (parameters) ranging from several tens to several hundreds, for example, a current value or a voltage value of power necessary for operating the target device.

As described above, in a case where the abnormality detection technique described in Non Patent Literature 1 and Non Patent Literature 2 is applied to a case where variation occurs in normal data, it is conceivable to learn a desired regression model by a learning device (computer) to which the abnormality detection technique is applied. In this case, in the learning device (hereinafter, also referred to as a “conventional device”), the normal data is clustered so as to cover all patterns, and the inferring device performs the abnormality detection using the regression model learned as a result. Here, from a physical viewpoint, the operating conditions of the target device suitable for abnormality detection are often limited. For example, in the abnormality detection of a rotary machine, normal data collected from the rotary machine at the time of energization may include the influence of electromagnetic noise due to the current. Therefore, in this case, it is desirable that the conventional device perform analysis (construction and evaluation of a regression model) by limiting to normal data collected from the rotary machine at the time of non-energization. However, the conventional device has a problem that it is difficult to perform the analysis as described above at present, and as a result, the number of steps required for learning the regression model increases.

The present disclosure has been made to solve the above problems, and an object of the present disclosure is to provide a learning device capable of reducing man-hours needed for learning as compared with the related art when learning a regression model for detecting an abnormality of a target device using training data having variation.

### Solution to Problem

A learning device according to the present disclosure includes: processing circuitry configured to
construct, on a basis of training data explainable by a plurality of explanatory variables and a first explanatory variable that is an explanatory variable designated from an outside and is one of the plurality of explanatory variables, a first regression model applicable to the training data and the first explanatory variable; select a second explanatory variable from among the plurality of explanatory variables, and to select, from the training data, a second explanatory variable with which target data regarded as varying on a basis of the constructed first regression model is separable from the training data; and construct, using training data after the target data is separated on a basis of the selected second explanatory variable and the first explanatory variable, a second regression model applicable to the training data and the first explanatory variable.

### Advantageous Effects of Invention

According to the present disclosure, when learning a model for detecting an abnormality of a target device by using data having variation collected from the target device, man-hours required for learning can be reduced as compared with the related art.

### BRIEF DESCRIPTION OF DRAWINGS

FIG. 1 is a diagram illustrating a configuration example of a state monitoring system according to a first embodiment.

FIG. 2 is a diagram illustrating a configuration example of a learning device according to the first embodiment.

FIG. 3 is a diagram illustrating an example of vibration data and control information data in the first embodiment.

FIG. 4 is a diagram illustrating a configuration example of a global learning unit (a global model constructing unit and a model evaluating unit) in the first embodiment.

FIG. 5 is a diagram illustrating an example of an image of a global model in the first embodiment.

FIG. 6 is a diagram illustrating an example of an image of a global model in the first embodiment.

FIGS. 7A, 7B and 7C are diagrams illustrating a specific example of classification processing by a filter processing unit in the first embodiment.

FIG. 8 is a diagram illustrating a configuration example of a local learning unit (range selecting unit, local model constructing unit, and model evaluating unit) according to the first embodiment.

FIG. 9 is a diagram for describing a specific example of processing by a distribution calculating unit in the first embodiment.

FIG. 10 is a diagram illustrating an example of a probability distribution diagram generated by a second variable selection processing unit in the first embodiment.

FIG. 11 is a diagram illustrating an example of a distribution diagram of vibration data generated by a region evaluating unit according to the first embodiment.

FIG. 12 is a diagram illustrating an example of an image illustrating a calculation result of a prediction error generated by an image output unit in the first embodiment.

FIG. 13 is a flowchart for describing an operation example of the learning device according to the first embodiment.

FIGS. 14A and 14B are diagrams illustrating an example of a hardware configuration of the learning device according to the first embodiment.

FIG. 15 is a diagram illustrating a configuration example of a state inferring device according to the first embodiment.

FIG. 16 is a diagram illustrating a configuration example of an evaluating unit in the state inferring device according to the first embodiment.

FIG. 17 is a diagram illustrating an example of an image illustrating a comparison result generated by the image output unit in the first embodiment.

FIG. 18 is a flowchart for describing an operation example of the state inferring device according to the first embodiment.

FIGS. 19A and 19B are diagrams illustrating an example of a hardware configuration of the state inferring device according to the first embodiment.

FIG. 20A is a diagram for describing difficulty in selecting an appropriate regression model in a conventional device, and FIG. 20B is a diagram for describing difficulty in evaluating variation in training data (normal data) in the conventional device.

### DESCRIPTION OF EMBODIMENTS

Hereinafter, embodiments of the present disclosure will be described in detail with reference to the drawings.

### First Embodiment

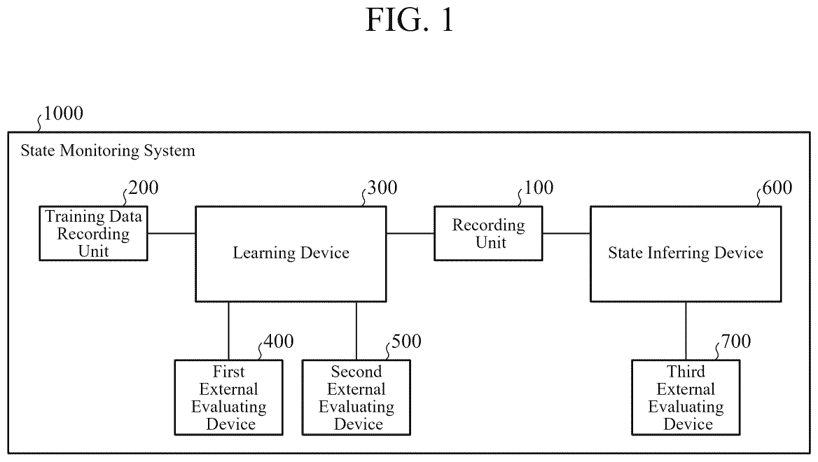

FIG. 1 is a diagram illustrating a configuration example of a state monitoring system 1000 according to a first embodiment. For example, as illustrated in FIG. 1, the state monitoring system 1000 includes a recording unit 100, a training data recording unit 200, a learning device 300, and a state inferring device 600.

The recording unit 100 includes a recording medium such as a hard disk drive (HDD) and a solid state drive (SDD). The recording unit 100 records data indicating a learned model constructed by the learning device 300.

The training data recording unit 200 includes a recording medium such as a hard disk drive (HDD) and a solid state drive (SDD). The training data recording unit 200 records training data used by the learning device 300 to construct a learned model.

Each of the learning device 300 and the state inferring device 600 is configured to be connectable to the recording unit 100. Further, the learning device 300 is configured to be connectable to the training data recording unit 200.

The learning device 300 constructs a learned model for performing abnormality detection of equipment (target device) such as a plant and a rotary machine by machine learning using the training data recorded in the training data recording unit 200. The learning device 300 causes the recording unit 100 to record data indicating the constructed learned model.

The state inferring device 600 uses the learned model indicated by the data recorded in the recording unit 100 by the learning device 300 to infer the state of the target device, thereby detecting an abnormality (for example, deterioration) of the target device.

Further, as illustrated in FIG. 1, for example, the state monitoring system 1000 includes a first external evaluating device 400, a second external evaluating device 500, and a third external evaluating device 700.

The first external evaluating device 400 and the second external evaluating device 500 are configured to be connectable to the learning device 300. The first external evaluating device 400 and the second external evaluating device 500 are devices that play a role as an interface for the learning device 300, such as transmitting an instruction from a user to the learning device 300 or presenting processing contents by the learning device 300 to the user.

The third external evaluating device 700 is configured to be connectable to the state inferring device 600. The third external evaluating device 700 is a device that plays a role as an interface for the state inferring device 600, such as transmitting an instruction from the user to the state inferring device 600 and presenting processing contents by the state inferring device 600 to the user.

In the following description, for convenience of description, first, details of the learning device 300 will be described, and next, details of the state inferring device 600 will be described.

### <Learning Device 300>

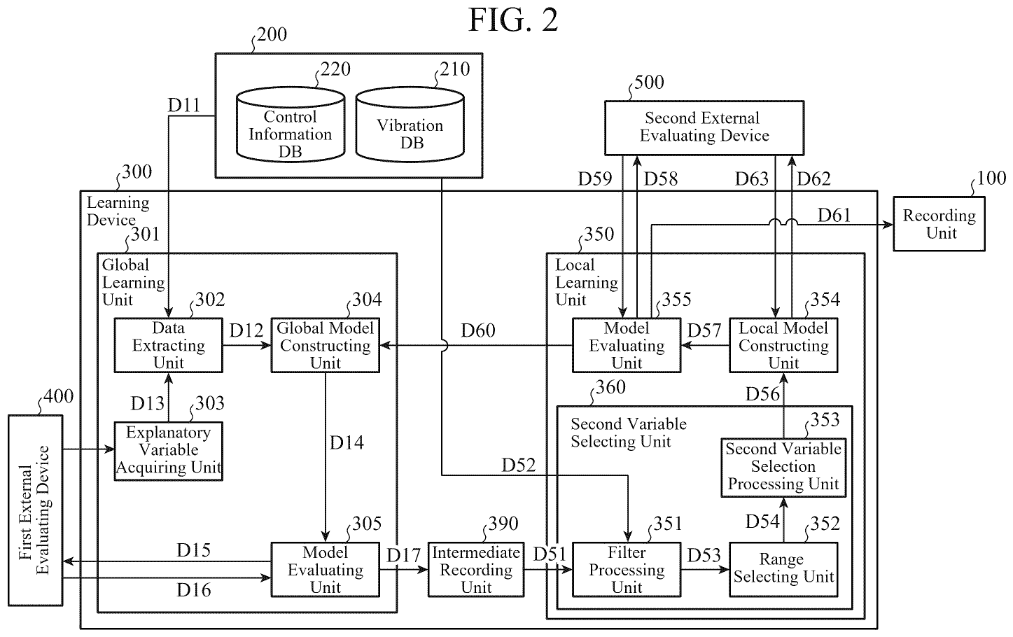

FIG. 2 is a diagram illustrating a configuration example of the learning device 300 according to the first embodiment. As illustrated in FIG. 2, for example, the learning device 300 includes a global learning unit 301, a local learning unit 350, and an intermediate recording unit 390.

The learning device 300 constructs a learned model for detecting an abnormality of the target device by performing two-stage machine learning of learning by the global learning unit 301 and learning by the local learning unit 350 using an objective variable described by a plurality of any explanatory variables (hereinafter, also referred to as “explanatory variable group”) as training data.

Specifically, first, the global learning unit 301 acquires a first explanatory variable selected from the explanatory variable group by a user having skill and knowledge about the target device. Further, the global learning unit 301 performs machine learning with the objective variable described by the acquired first explanatory variable as training data, and constructs a learned model applicable between the training data and the first explanatory variable. Further, the global learning unit 301 obtains evaluation for the learned model from the user via the first external evaluating device 400. Thus, the global learning unit 301 constructs a global learned model that has acquired validity from a physical viewpoint. The global learning unit 301 causes the intermediate recording unit 390 to record data indicating the constructed learned model.

Next, the local learning unit 350 uses the learned model indicated by the data recorded in the intermediate recording unit 390 by the global learning unit 301 to classify the above-described training data into “data regarded as varying (having a large variation)” and “data regarded as not varying (have small variation)”. Further, the local learning unit 350 searches for a second explanatory variable, which is an explanatory variable capable of accurately separating “data regarded as varying (having a large variation)” from the above-described training data and is different from the first explanatory variable selected by the user, from the above-described explanatory variable group. Note that, here, “capable of separating” or “separable” does not mean that “data regarded as varying (having a large variation)” can be completely separated from the training data, but means that the latter can be roughly separated from the former.

Then, the local learning unit 350 performs the machine learning using the training data after the “data regarded as varying (having a large variation)” is separated on the basis of the second explanatory variable that has been searched for and the above-described first explanatory variable, thereby constructing the local learned model applicable between the training data after the separation and the first explanatory variable. Here, the local learned model means a model learned by using training data obtained after “data regarded as varying (having a large variation)” is separated from a physical viewpoint.

Here, training data used for learning by the learning device 300 is recorded in the training data recording unit 200. For example, as illustrated in FIG. 2, the training data recording unit 200 includes a vibration DB 210 and a control information DB 220.

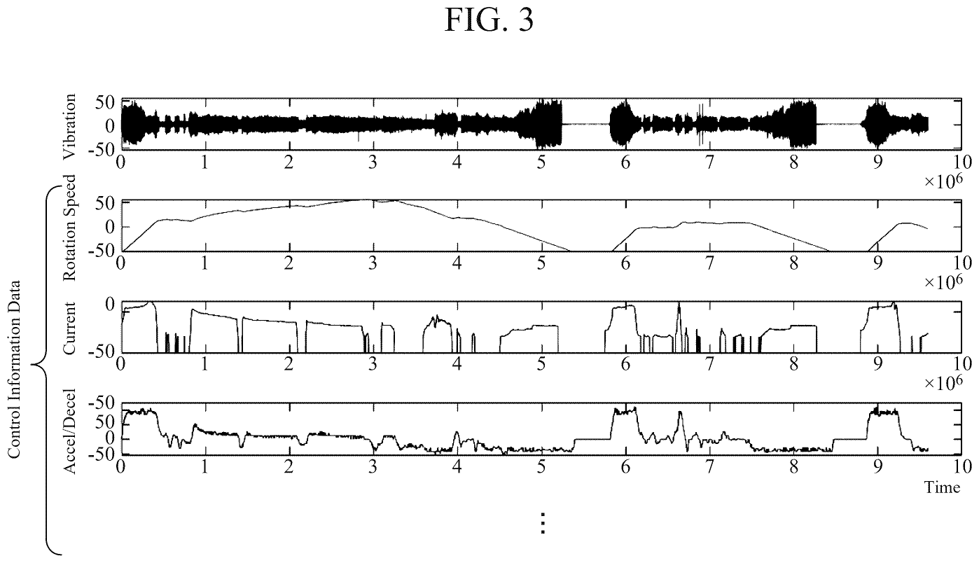

The vibration DB 210 records vibration data. The vibration data is, for example, data indicating a temporal change in vibration amplitude value as illustrated in the top graph of FIG. 3. Note that the vibration data may be data indicating a temporal change in the feature amount of the vibration amplitude value. In this case, the feature amount of the vibration amplitude value only needs to be, for example, an RMS value of the vibration amplitude value. Note that, in the following description, a case where the vibration data is the RMS value of the vibration amplitude value will be described as an example.

The control information DB 220 records control information data that is an explanatory variable. The control information data is data indicating a temporal change of the control information as illustrated in the second to fourth graphs from the top in FIG. 3, for example. Here, the control information is a parameter that determines an operating condition of the target device, and is, for example, a rotation speed in a case where the target device is a rotary machine, a current value of drive power of the rotary machine, Accel/Decel, or the like.

Note that each piece of the control information data recorded in the control information DB 220 and the vibration data recorded in the vibration DB 210 are temporally synchronized with each other. Further, in this case, the vibration data corresponds to an objective variable, and each piece of the control information data corresponds to an explanatory variable for explaining the vibration data.

Note that, in the following description, a case where the vibration data corresponds to the objective variable and each piece of control information data corresponds to the explanatory variable will be described as an example, but this is merely an example, and the objective variable and the explanatory variable may be data other than the above. In addition, in the following description, the explanatory variable group is also referred to as a control information group.

### <Global Learning Unit 301>

As illustrated in FIG. 2, for example, the global learning unit 301 includes a data extracting unit 302, an explanatory variable acquiring unit 303, a global model constructing unit 304, and a model evaluating unit 305.

### (Explanatory Variable Acquiring Unit 303)

First, the user selects any control information from an explanatory variable group (control information group) for describing vibration data, and inputs the selected control information to the first external evaluating device 400. Here, it is assumed that the user selects “rotation speed” as the control information for easy understanding of the description. The explanatory variable acquiring unit 303 acquires the control information input by the user to the first external evaluating device 400 from the first external evaluating device 400 as a first explanatory variable x1. Further, the explanatory variable acquiring unit 303 outputs the acquired data indicating the first explanatory variable x1 to the data extracting unit 302 as a variable descriptor D13.

### (Data Extracting Unit 302)

The data extracting unit 302 acquires the variable descriptor D13 from the explanatory variable acquiring unit 303. The data extracting unit 302 acquires the control information data corresponding to the acquired variable descriptor D13 from the control information DB 220 in the training data recording unit 200. Here, since variable descriptor D13 indicates “rotation speed”, the data extracting unit 302 acquires the control information data second from the top in FIG. 3 from the control information DB 220.

Further, the data extracting unit 302 acquires vibration data from the vibration DB 210 in the training data recording unit 200. Then, the data extracting unit 302 outputs the acquired control information data and vibration data to the global model constructing unit 304 as learning data D12.

### (Global Model Constructing Unit 304)

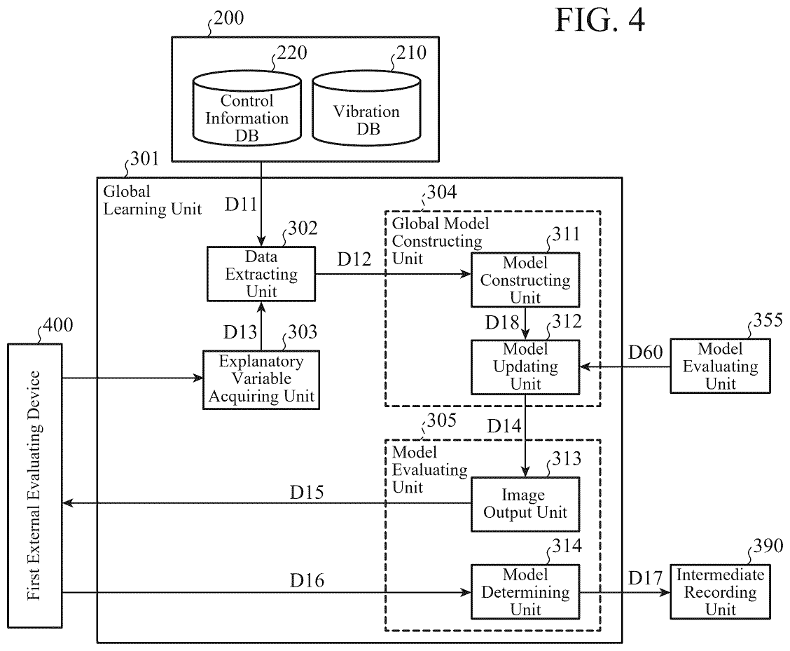

The global model constructing unit 304 learns a regression model applicable to the vibration data and the first explanatory variable x1 on the basis of the vibration data that is explainable by the plurality of explanatory variables and the first explanatory variable x1 that is an explanatory variable designated from the outside and is one of the plurality of explanatory variables. As illustrated in FIG. 4, for example, the global model constructing unit 304 includes a model constructing unit 311 and a model updating unit 312.

The model constructing unit 311 acquires the learning data D12 from the data extracting unit 302. The model constructing unit 311 constructs a regression model by performing learning by unsupervised learning using the acquired learning data D12. At this time, the model constructing unit 311 performs learning by unsupervised learning using the control information data (rotation speed) included in the learning data D12 as an explanatory variable and the vibration data (RMS value of vibration amplitude value) included in the learning data D12 as an objective variable. Note that, as a learning method in this case, it is sufficient if a known learning method such as linear regression, polynomial regression, or Gaussian process regression is used. Further, in the following description, the regression model constructed here is also referred to as a “global model”.

Note that the global model is a model that receives the first explanatory variable x1 (control information data) as an input and outputs the objective variable (vibration data), but the global model only needs to reproduce a rough regression tendency between the control information data and the vibration data. Thus, when constructing the global model, the model constructing unit 311 does not necessarily need to use all the control information data and vibration data included in the learning data D12. For example, the model constructing unit 311 may construct the global model using the control information data and the vibration data corresponding to any time range designated by the user.

The model constructing unit 311 outputs data (hereinafter, also referred to as “global model data”) indicating the constructed global model and the control information data and the vibration data used for learning the global model to the model updating unit 312 as data D18.

Note that the model constructing unit 311 may construct a plurality of patterns of global models. In this case, the model constructing unit 311 outputs the global model data for each pattern and the control information data and the vibration data used for the learning to the model updating unit 312 as data D18.

The model updating unit 312 acquires the data D18 from the model constructing unit 311. Further, when a model evaluating unit 355 of the local learning unit 350 to be described later outputs data D60, the model updating unit 312 acquires the data D60 from the model evaluating unit 355 and updates (reconstructs) the global model according to an instruction of the user. Update processing in this case will be described later.

When the global model is updated, the model updating unit 312 outputs, to the model evaluating unit 305, data obtained by combining data indicating the updated global model with the control information data and the vibration data used at the time of update as data D14. Further, when the model evaluating unit 355 does not output the data D60 and does not update the global model, the model updating unit 312 outputs the data D18 as it is to the model evaluating unit 305 as the data D14.

### (Model Evaluating Unit 305)

The model evaluating unit 305 receives an evaluation of the global model indicated by the data included in the data D14 from the outside (for example, the user). As illustrated in FIG. 4, for example, the model evaluating unit 305 includes an image output unit 313 and a model determining unit 314.

The image output unit 313 acquires the data D14 from the model updating unit 312. On the basis of the global model data included in the acquired data D14, the image output unit 313 images the global model indicated by the data, and generates data (hereinafter, also referred to as “global model image data”) indicating an image of the global model. The image output unit 313 outputs the generated global model image data to the first external evaluating device 400 as data D15.

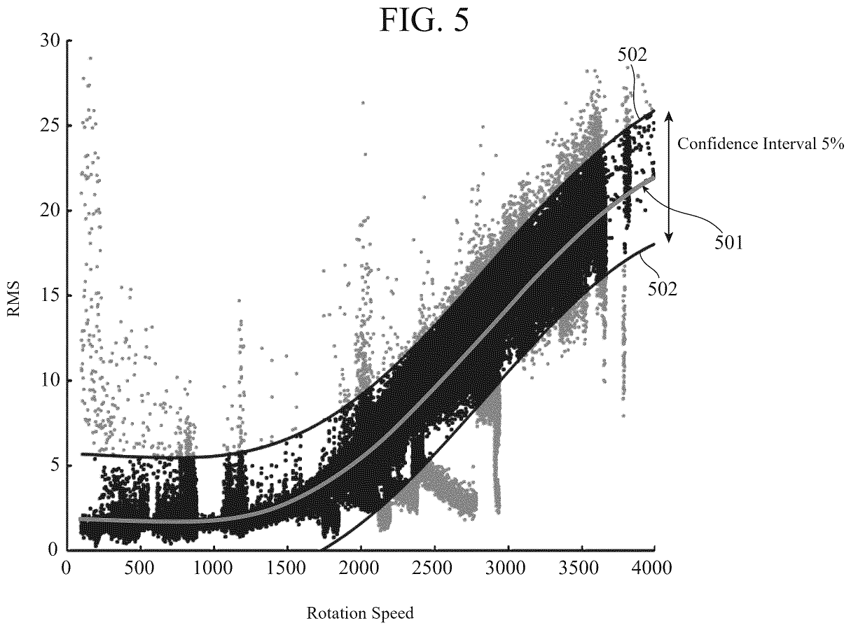

An example of an image of the global model is illustrated in FIG. 5. For example, in FIG. 5, reference numeral 501 denotes a curve (prediction line) indicating a regression equation obtained by the global model, and reference numeral 502 denotes a boundary of a confidence interval (for example, a curve 501±5%) set for the curve (prediction line) indicating the regression equation.

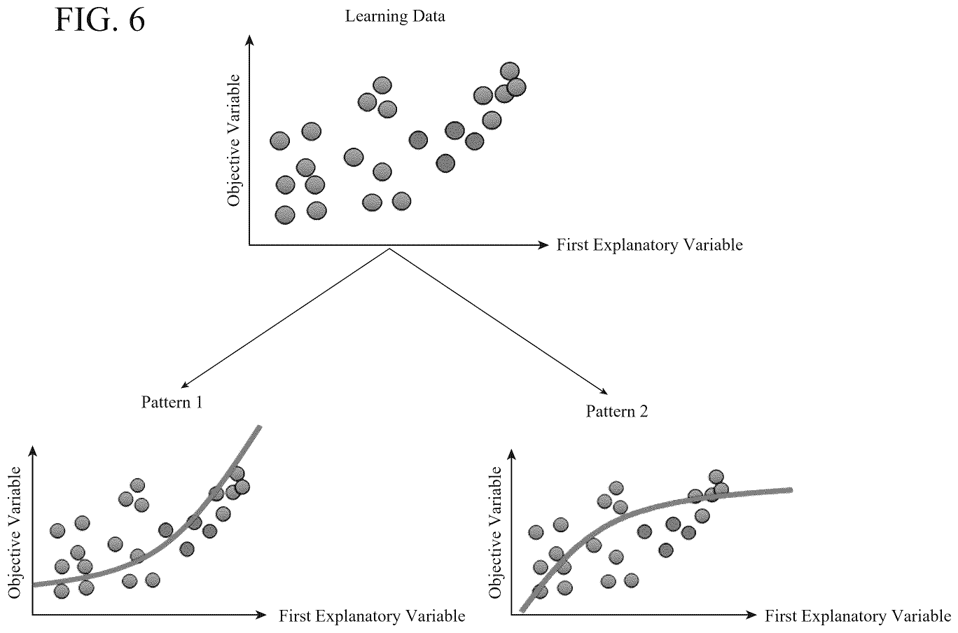

Note that, when the data D14 includes a plurality of patterns of global model data, the image output unit 313 generates global model image data for each pattern on the basis of each global model data, for example, as illustrated in FIG. 6, and outputs the generated global model image data to the first external evaluating device 400 as the data D15.

The first external evaluating device 400 acquires the data D15 from the image output unit 313. The first external evaluating device 400 displays one or more images of the global model on a display unit (not illustrated) such as a display on the basis of the acquired data D15. When there is one image of the global model displayed on the display unit, the user checks the image, determines whether or not the global model is considered to be correct from a physical viewpoint, and inputs a determination result indicating that the global model is considered to be correct to the first external evaluating device 400 when the global model is considered to be correct. Further, when there is a plurality of images of the global model displayed on the display unit, the user checks each of the images, selects a global model considered to be correct from a physical viewpoint, and inputs a selection result to the first external evaluating device 400.

Furthermore, at this time, the user designates, as a search width S, a range in which a variation of the vibration data is considered to be relatively small or a range in which characteristics of the target device is considered to be reflected in the vibration data, of the time range on the time series of the control information data (here, the rotation speed) used for the learning, and inputs the range to the first external evaluating device 400. Here, the search width S is a variable used when the range selecting unit 352 of the local learning unit 350 to be described later searches for a region having a small variation in vibration data.

The first external evaluating device 400 outputs data obtained by adding data indicating the determination result or the selection result by the user and data indicating the search width S input from the user to the model determining unit 314 as data D16.

Note that, when there is no global model that is considered to be correct from a physical viewpoint, the user only needs to perform any one of the following two operations, for example. For example, the user rejects the global model constructed at that time by using the first external evaluating device 400, and inputs control information different from the initially input control variable (here, rotation speed) to the first external evaluating device 400. Then, the different control information may be acquired by the explanatory variable acquiring unit 303 as a new first explanatory variable x1, and thereafter, the global model constructing unit 304 only needs to be caused to reconstruct the global model through processing similar to the above.

Alternatively, the user leaves the first explanatory variable x1 as it is, excludes data regarded as varying from the vibration data on the basis of the image of the global model using the first external evaluating device 400, and then causes the global model constructing unit 304 to reconstruct the global model. The user only needs to repeat any of the above operations until a global model considered to be correct from a physical viewpoint is constructed.

The model determining unit 314 acquires the data D16 from the first external evaluating device 400. On the basis of the acquired data D16, the model determining unit 314 causes the intermediate recording unit 390 to record, as data D17, data indicating a global model that the user has determined to be correct from a physical viewpoint, or data indicating a global model that the user has selected as a correct model from a physical viewpoint. The model indicated by the data D17 corresponds to the above-described global learned model.

Note that, at that time, the model determining unit 314 sets the data indicating the search width S included in the data D16 as a range descriptor, includes the range descriptor and an identifier (for example, a name) of the control information data used for learning of the global model in the data D17, and records the data in the intermediate recording unit 390.

### (Intermediate Recording Unit 390)

The intermediate recording unit 390 records the data D17. That is, the intermediate recording unit 390 records data (global model data) indicating a global model corresponding to a global learned model, an identifier of the control information data, and a range descriptor.

### <Local Learning Unit 350>

For example, as illustrated in FIG. 2, the local learning unit 350 includes a second variable selecting unit 360, a local model constructing unit 354, and a model evaluating unit 355. Further, the second variable selecting unit 360 includes, for example, a filter processing unit 351, a range selecting unit 352, and a second variable selection processing unit 353.

### (Filter Processing Unit 351)

The filter processing unit 351 acquires the data D17 (global model data, the identifier of the control information data, and range descriptor) recorded in the intermediate recording unit 390 as a global model descriptor D51.

Further, the filter processing unit 351 refers to the training data recording unit 200 and acquires the vibration data recorded in the vibration DB 210 and data corresponding to the identifier of the control information data included in the data D17 among the control information data recorded in the control information DB 220 as the data D52.

Then, on the basis of the acquired global model descriptor D51 and data D52, the filter processing unit 351 classifies (filters) the vibration data included in the data D52 into data regarded as varying and data regarded as not varying, and labels both the classified data.

For example, the filter processing unit 351 determines the degree of variation of the vibration data on the basis of the global model, and assigns a label “Data A” to data that is regarded as varying among the vibration data, and a label “Data B” to data that is regarded as not varying among the vibration data. Then, the filter processing unit 351 outputs data obtained by combining the vibration data to which the label is assigned and the above-described global model descriptor D51 to the range selecting unit 352 as data D53.

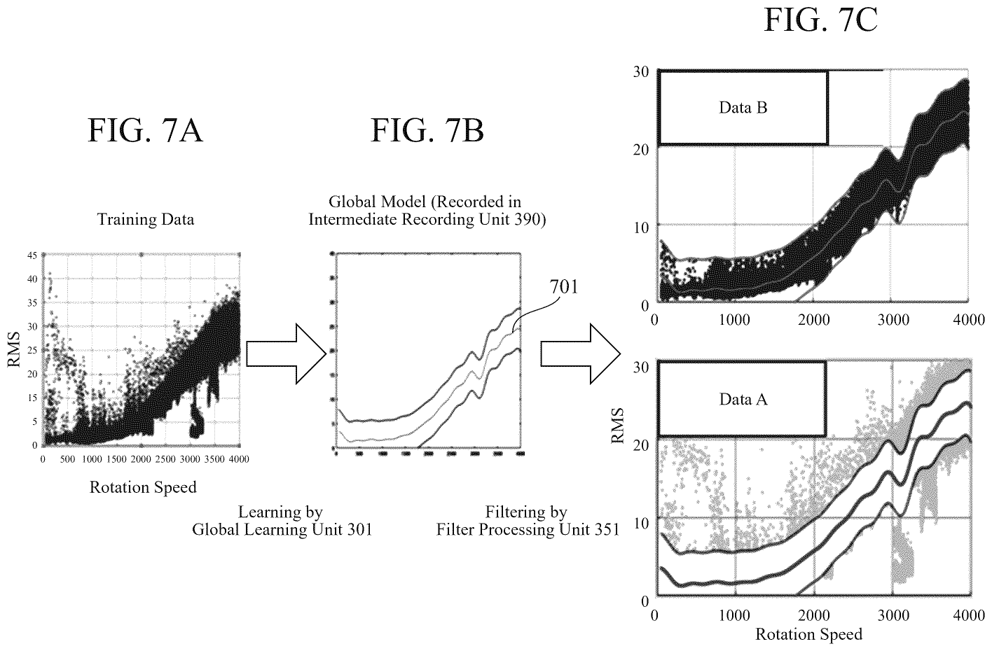

A specific example of the classification processing by the filter processing unit 351 is illustrated in FIG. 7. For example, FIG. 7A illustrates a distribution diagram of vibration data (RMS value) in a case where the first explanatory variable x1 (rotation speed) is taken on the horizontal axis and the vibration data is taken on the vertical axis. Further, FIG. 7B illustrates an image of the global model indicated by the global model data included in the data D17 recorded in the intermediate recording unit 390. Further, FIG. 7C is a distribution diagram of vibration data after the classification processing by the filter processing unit 351.

For example, the filter processing unit 351 superimposes FIGS. 7A and 7B on each other, determines vibration data located outside the confidence interval set for a curve (prediction line) 701 in the global model of FIG. 7B among the vibration data illustrated in FIG. 7A as data regarded as varying, and labels the data with “Data A” (lower diagram of FIG. 7C). Further, the filter processing unit 351 regards the vibration data located inside the confidence interval among the vibration data illustrated in FIG. 7A as data regarded as not varying, and labels the data with “Data B” (upper diagram of FIG. 7C).

Note that, in the following description, in order to make the description easy to understand, data that is regarded as varying by the filter processing unit 351 is also simply referred to as “Data A”, and data that is regarded as not varying is also simply referred to as “Data B”. These pieces of data are also collectively referred to as “labeled data”.

### (Range Selecting Unit 352)

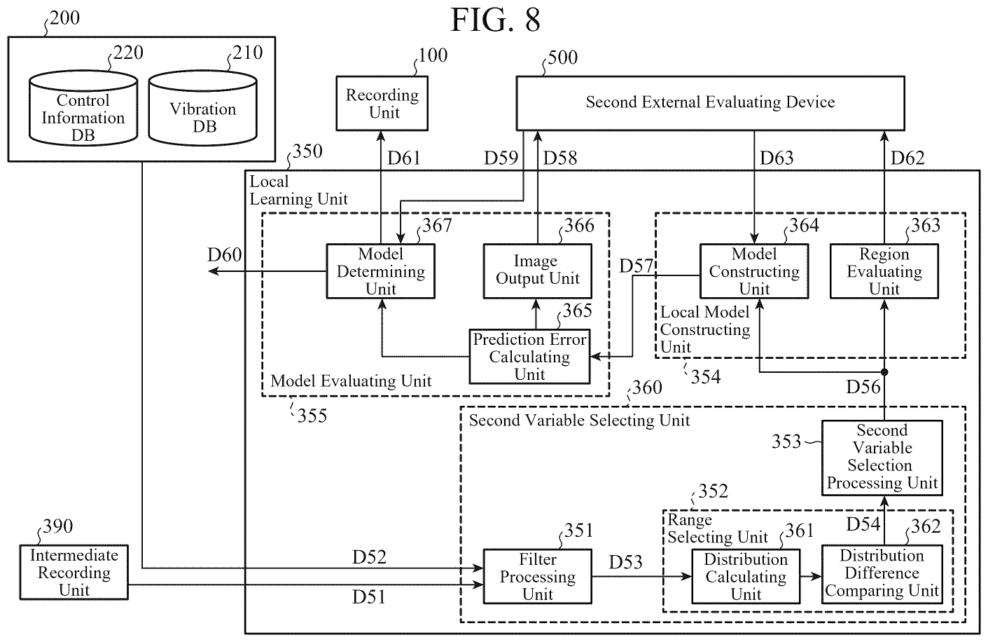

For example, as illustrated in FIG. 8, the range selecting unit 352 includes a distribution calculating unit 361 and a distribution difference comparing unit 362.

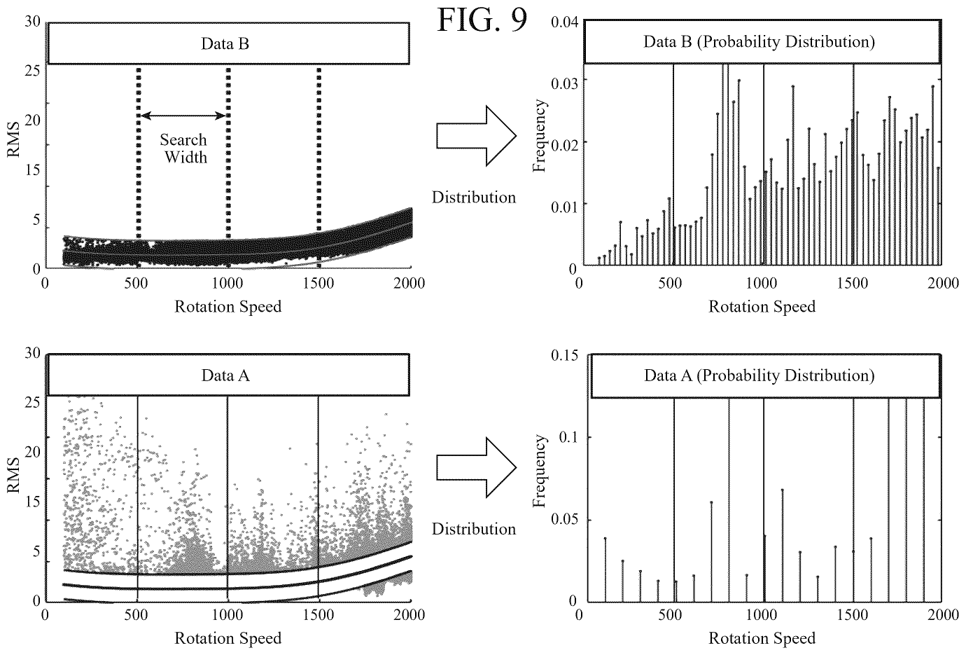

The distribution calculating unit 361 acquires the data D53 from the filter processing unit 351. The distribution calculating unit 361 analyzes the distribution of Data A and Data B on the basis of the labeled data included in the acquired data D53. Specifically, for example, as illustrated in FIG. 9, the distribution calculating unit 361 calculates a probability distribution pA of Data A and a probability distribution pB of Data B for the first explanatory variable x1, and outputs data indicating the calculated probability distribution and the data D53 to the distribution difference comparing unit 362.

Note that the “search width” illustrated in FIG. 9 indicates the above-described search width input by the user via the first external evaluating device 400. In the example of FIG. 9, the search width is set in such a manner that the rotation speed is between 500 and 1000. This means that the user has determined that the variation in the vibration data is relatively small when the rotation speed is between 500 and 1000.

The distribution difference comparing unit 362 acquires data indicating the probability distributions pA and pB and the data D53 from the distribution calculating unit 361. The distribution difference comparing unit 362 obtains a difference between the probability distribution pA and the probability distribution pB on the basis of the acquired data indicating the probability distributions pA and pB. At this time, the distribution difference comparing unit 362 selects, from the search width indicated by the range descriptor included in the data D53, a range in which the probability distribution pB is larger than the probability distribution pA, which is a range on the time series of the control information data (rotation speed) having the largest difference.

Specifically, the distribution difference comparing unit 362 calculates each difference pB−pA on the basis of the probability distributions pA and pB acquired from the distribution calculating unit 361. At this time, assuming that the search width is S, the distribution difference comparing unit 362 selects a range Ω in which pB|Ω−pA|Ω (where Ω=[a, a+S] and a is any value of the first explanatory variable x1) is the maximum from the search width S, and sets the selected range Ω as a new range descriptor. Then, the distribution difference comparing unit 362 outputs data obtained by combining the new range descriptor, the labeled data (Data A and Data B), and the global model descriptor D51 to the second variable selection processing unit 353 as data D54.

Note that, here, although an example has been described in which the distribution difference comparing unit 362 selects the range Ω in which pB|Ω−pA|Ω is the maximum, the distribution difference comparing unit 362 is not limited to this, and for example, a range Ω in which pB|Ω−pA|Ω is equal to or more than a predetermined value may be selected, and the selected range Ω may be used as a new range descriptor.

### (Second Variable Selection Processing Unit 353)

The second variable selection processing unit 353 acquires the data D54 from the range selecting unit 352. Then, at the time of learning in the global learning unit 301, the second variable selection processing unit 353 selects, from the explanatory variable group, an explanatory variable (control information) other than the first explanatory variable x1 selected by the user, the explanatory variable capable of accurately separating Data A and Data B. Note that, in the following description, the explanatory variable selected here is also referred to as a “second explanatory variable x2”.

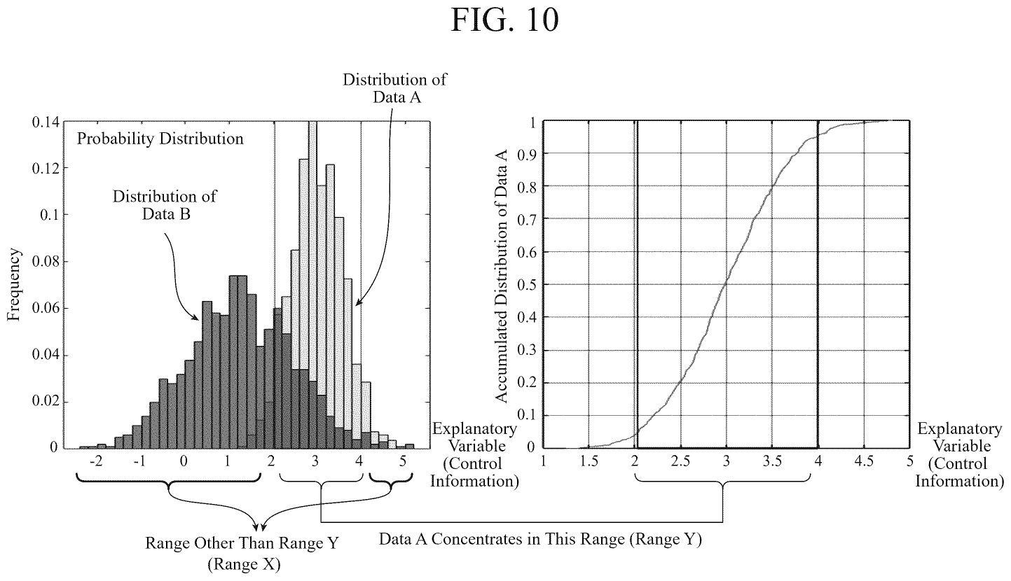

For example, the second variable selection processing unit 353 generates a probability distribution diagram as illustrated in FIG. 10. In FIG. 10, the horizontal axis indicates a certain explanatory variable other than the first explanatory variable x1 and indicates a candidate explanatory variable of the second explanatory variable x2. Further, the vertical axis indicates the appearance frequency of Data A and Data B present in the above-described range Ω included in the data D54.

At this time, the second variable selection processing unit 353 searches for an explanatory variable by the following procedure while sequentially changing explanatory variables that are candidates for the second explanatory variable x2, and selects a retrieved explanatory variable as the second explanatory variable x2.
(1) For example, in a probability distribution diagram as illustrated in FIG. 10, when the length of the entire horizontal axis is “100”, the second variable selection processing unit 353 sets a range on the horizontal axis in which the ratio of Data A is equal to or more than “100−ε”% (ε is a small positive integer) among all pieces of Data A as Y (first range). For example, the second variable selection processing unit 353 sets ε=5, and sets a range of the horizontal axis so as to include 95% or more of Data A of all pieces of Data A as Y.
(2) Next, the second variable selection processing unit 353 sets a range excluding the range Y as a range X (second range) on the horizontal axis of the probability distribution diagram, and searches for an explanatory variable in which the ratio of Data B among all pieces of data included in the range X is equal to or more than a predetermined value (for example, 80%). Then, the second variable selection processing unit 353 selects the retrieved explanatory variable as the second explanatory variable x2. Note that, when the second variable selection processing unit 353 searches for a plurality of explanatory variables in which the ratio of Data B is equal to or more than a predetermined value among all the pieces of data included in the range X, for example, the second variable selection processing unit 353 selects an explanatory variable in which the ratio of Data B is the largest in the range X as the second explanatory variable x2.

Note that, when the search fails, the second variable selection processing unit 353 repeats the above (1) and (2) while sequentially changing the explanatory variables that are candidates for the second explanatory variable x2. Then, the second variable selection processing unit 353 outputs data obtained by combining the second explanatory variable x2 selected by the above procedure and the above data D54 to the local model constructing unit 354 as data D56.

The second explanatory variable x2 is a variable different from the first explanatory variable x1 designated by the user at the time of learning in the global learning unit 301, and is a variable with a high possibility of accurately (precisely) separating Data A and Data B by being combined with the first explanatory variable x1.

### (Local Model Constructing Unit 354)

For example, as illustrated in FIG. 8, the local model constructing unit 354 includes a region evaluating unit 363 and a model constructing unit 364.

### (Region Evaluating Unit 363)

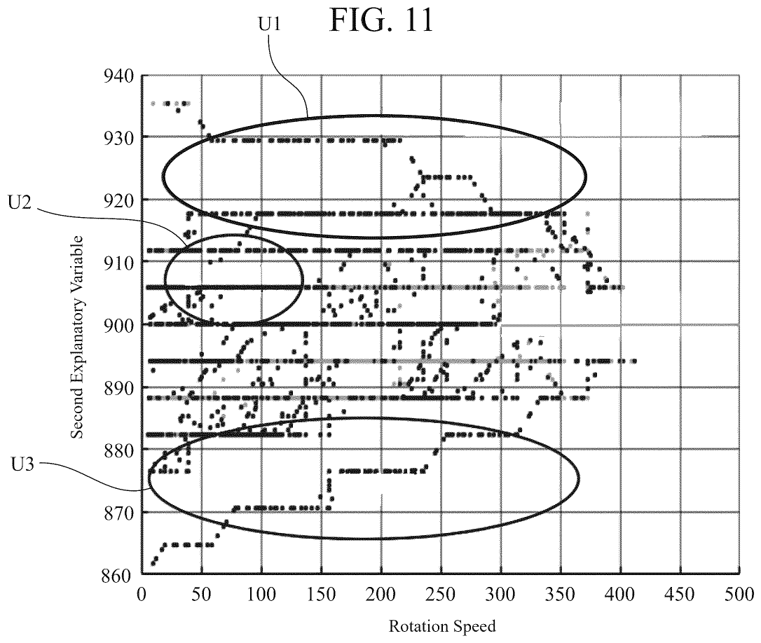

The region evaluating unit 363 acquires the data D56 from the second variable selection processing unit 353. The region evaluating unit 363 generates a distribution diagram of vibration data as illustrated in FIG. 11, for example, by using the second explanatory variable x2 and the first explanatory variable x1 (here, the rotation speed) included in the acquired data D56.

For example, as illustrated in FIG. 11, this distribution diagram is a diagram in which the first explanatory variable x1 (rotation speed) is taken on the horizontal axis, the second explanatory variable x2 is taken on the vertical axis, and vibration data is displayed in a region (hereinafter, also referred to as a “combination region”) determined by a combination of both variables, and is a diagram illustrating a region in which each of Data A and Data B appears in the combination region. Note that, in FIG. 11, Data A is indicated by a gray dot, and Data B is indicated by a black dot.

As described above, by displaying Data A and Data B in the combination region, the region evaluating unit 363 can clearly indicate a region having a relatively large number of pieces of Data A and a region having a relatively small number of pieces of Data A (indicated by reference numerals U1 to U3 in FIG. 11) in the combination region. The region evaluating unit 363 outputs data indicating the generated distribution diagram to the second external evaluating device 500 as data D62.

The second external evaluating device 500 acquires the data D62 from the region evaluating unit 363. The second external evaluating device 500 displays an image of the distribution diagram on a display unit (not illustrated) such as a display on the basis of the acquired data D62.

The user refers to the image of the distribution diagram displayed on the display unit, selects a region having a relatively small number of pieces of Data A among the combination regions, for example, areas U1 to U3 in FIG. 11, and inputs the selected region to the second external evaluating device 500. At this time, the user may select only one region such as the region U1, or may select a plurality of regions such as the regions U1 to U3. The second external evaluating device 500 outputs the data indicating the input region to the model constructing unit 364 as the region range data D63.

The model constructing unit 364 acquires the region range data D63 from the second external evaluating device 500. Further, the model constructing unit 364 also acquires the data D56 from the second variable selection processing unit 353. Then, the model constructing unit 364 specifies vibration data included in the regions U1 to U3 in FIG. 11, for example, on the basis of the acquired region range data D63 and data D56, performs unsupervised learning using the specified vibration data and the control information data corresponding to the vibration data as training data, and constructs a regression model. Note that, in the following description, the regression model constructed here is also referred to as a “local model”. The local model is a model that receives the first explanatory variable x1 (control information data) as input and outputs the objective variable (vibration data).

Note that, in a case where a plurality of regions is selected by the user, the model constructing unit 364 constructs the local model for each of the selected regions. Further, at this time, the model constructing unit 364 uses a learning model similar to the learning model used by the global model constructing unit 304 of the global learning unit 301. Here, both the learning models are not necessarily the same model.

The model constructing unit 364 outputs data obtained by combining the data (hereinafter, also referred to as “local model data”) indicating the constructed local model and the vibration data (Data A and Data B) used for learning to the model evaluating unit 355 as data D57.

### (Model Evaluating Unit 355)

The model evaluating unit 355 receives evaluation from the outside (for example, the user) with respect to the local model indicated by the local model data included in the data D57. As illustrated in FIG. 8, for example, the model evaluating unit 355 includes a prediction error calculating unit 365, an image output unit 366, and a model determining unit 367.

The prediction error calculating unit 365 acquires the data D57 from the model constructing unit 364. The prediction error calculating unit 365 calculates a prediction error of the local model on the basis of the acquired data D57.

For example, the prediction error calculating unit 365 inputs the first explanatory variable x1 (rotation speed) to the local model indicated by the local model data included in the data D57, and calculates how much the vibration data (RMS value) output from the local model at this time has an error with respect to the vibration data to be originally output. At this time, the prediction error calculating unit 365 calculates the prediction error with a value such as a mean absolute percentage error (MAPE). The prediction error calculating unit 365 outputs the first explanatory variable x1 and the vibration data used to calculate the prediction error and data indicating the calculated prediction error to the image output unit 366.

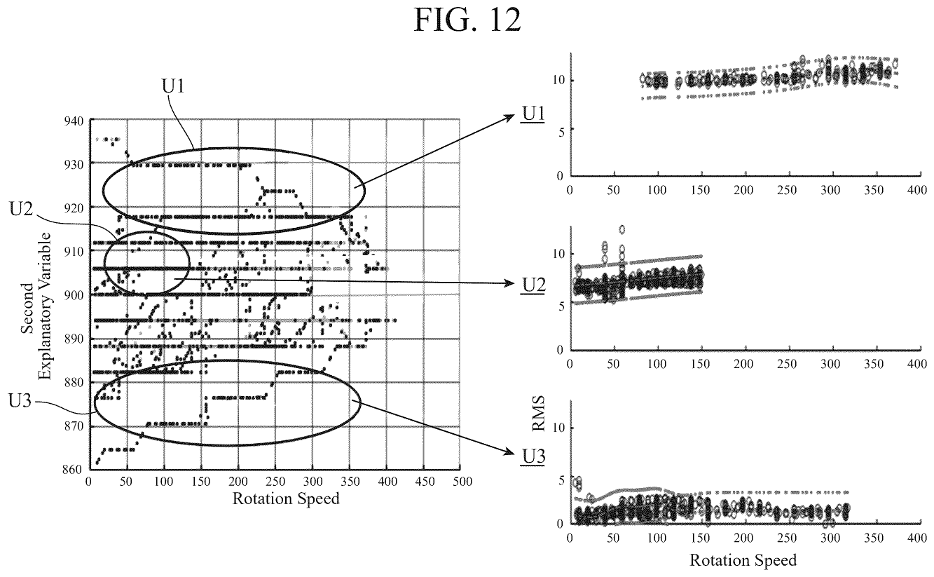

The image output unit 366 acquires the first explanatory variable x1 and the vibration data and the data indicating the prediction error from the prediction error calculating unit 365. Then, on the basis of the acquired data, the image output unit 366 generates, for each region, data indicating an image from which the prediction result can be seen, for example, as illustrated on the right side of FIG. 12. Then, the image output unit 366 outputs data obtained by combining the data indicating the generated image and the data indicating the prediction error to the second external evaluating device 500 as data D58. Note that, in the image illustrated on the right side of FIG. 12, similarly to the image of the global model illustrated in FIG. 5, a curve (prediction line) indicating the regression equation obtained by the local model and the boundary of the confidence interval (for example, curve±5%) set for the curve (prediction line) indicating the regression equation are illustrated.

The second external evaluating device 500 acquires the data D58 from the image output unit 366. The second external evaluating device 500 displays, for example, an image illustrated on the right side of FIG. 12 on a display unit (not illustrated) such as a display on the basis of the acquired data D58. The user refers to the image displayed on the display unit, determines a local model to be finally output to the recording unit 100 from among the local models, and inputs an identifier of the determined local model to the second external evaluating device 500. The second external evaluating device 500 outputs the input identifier of the local model to the model determining unit 367 as data D59.

The model determining unit 367 acquires the data D59 from the second external evaluating device 500. The model determining unit 367 causes the recording unit 100 to record data indicating the local model finally determined to be output by the user on the basis of the acquired data D59 as data D61.

Further, at this time, the model determining unit 367 includes data (hereinafter, also referred to as “control condition data”) indicating a condition (hereinafter, also referred to as a “control condition”) of the control information (explanatory variable) when the local model determined to be output by the user is constructed in the data D61 and causes the recording unit 100 to record the data. Here, the control condition refers to, for example, the type of the first explanatory variable x1 (such as the rotation speed), the type of the second explanatory variable x2 (other than the rotation speed), the range of the first explanatory variable x1 and the range of the second explanatory variable x2 in which the training data at the time of constructing the local model has been present, and the like.

Note that when the user sets a plurality of local models as output targets, the model determining unit 367 causes the recording unit 100 to record the plurality of pieces of local model data. Further, in this case, the model determining unit 367 causes the recording unit 100 to record the control condition data in association with each other for each of the plurality of local models.

Note that, in a case where the user has referred to the image displayed on the display unit but has not found the local model to be finally output to the recording unit 100, for example, the user inputs the fact to the second external evaluating device 500. The second external evaluating device 500 outputs data indicating that there is no local model to be output to the model determining unit 367 as the data D59.

Upon acquiring the data D59, the model determining unit 367 acquires the data D57 (Data obtained by combining the local model data and the vibration data (Data A and Data B) used for learning the local model) from the prediction error calculating unit 365, and outputs the acquired data D57 to the model updating unit 312 of the global learning unit 301 as the data D60.

The model updating unit 312 acquires the data D60 from the model determining unit 367. Upon acquiring the data D60, the model updating unit 312 causes the display unit of the first external evaluating device 400 to display the content of the data D60. Further, the model updating unit 312 causes the display unit of the first external evaluating device 400 to instruct the user to perform update processing (that is, re-creation) of the global model.

In response to this display, the user reselects an explanatory variable different from the first explanatory variable x1 initially selected in constructing the global model, and inputs the selected new explanatory variable to the first external evaluating device 400. Hereinafter, the model updating unit 312 updates (reconstructs) the global model by a method similar to that of the model constructing unit 311 described above.

Note that, here, an example has been described in which the user reselects an explanatory variable different from the first explanatory variable x1 initially selected at the time of constructing the global model, and updates (reconstructs) the global model, but the method of updating (reconstructing) the global model is not limited thereto. For example, while keeping the first explanatory variable x1 initially selected at the time of constructing the global model, the user may change the range of the first explanatory variable x1 from the initial state, such as narrowing the range of the first explanatory variable x1. In this case, the model updating unit 312 only needs to update (reconstruct) the global model using the training data included in the changed range.

In addition, for example, the model updating unit 312 may instruct the user to input the search width again via the first external evaluating device 400 without updating the global model. In this case, the user inputs a new search width via the first external evaluating device 400, and the new search width is recorded as a range descriptor in the intermediate recording unit 390. Hereinafter, the second variable selection processing unit 353 selects a new second explanatory variable x2 on the basis of the new range descriptor, and the local learning unit 350 reconstructs the local model.

Alternatively, the model updating unit 312 may instruct the user to reselect the regions U1 to U3 illustrated in FIG. 11 via the second external evaluating device 500 without updating the global model. In this case, the user inputs a new region via the second external evaluating device 500, and data indicating the new region is sent to the model constructing unit 364 as region range data. Hereinafter, the local model is reconstructed by the model constructing unit 364 using the new region range data.

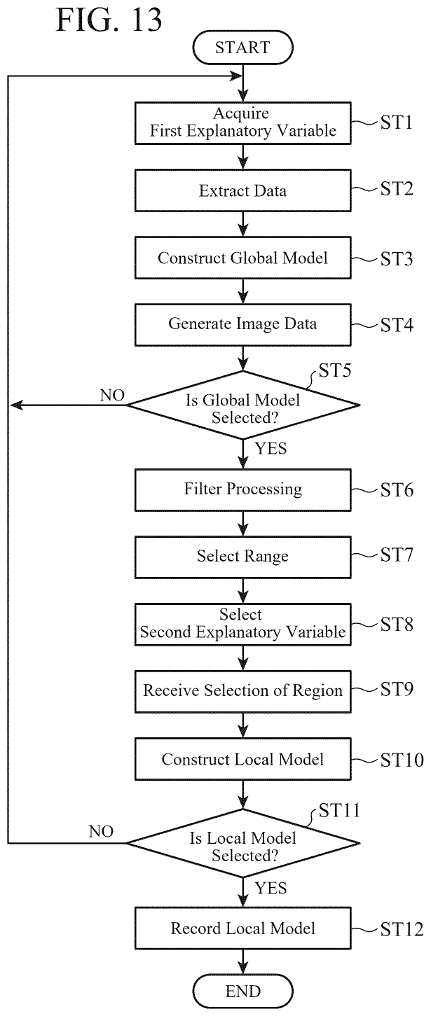

Next, an operation example of the learning device 300 according to the first embodiment will be described with reference to a flowchart illustrated in FIG. 13.

First, the explanatory variable acquiring unit 303 acquires the control information input by the user to the first external evaluating device 400 from the first external evaluating device 400 as the first explanatory variable x1 (step ST1). The explanatory variable acquiring unit 303 outputs the acquired data indicating the first explanatory variable x1 to the data extracting unit 302 as the variable descriptor D13.

Next, the data extracting unit 302 acquires the control information data corresponding to the acquired variable descriptor D13 from the control information DB 220 in the training data recording unit 200. Further, the data extracting unit 302 acquires vibration data as training data from the vibration DB 210 in the training data recording unit 200 (step ST2).

Next, the model constructing unit 311 constructs a global model using the data acquired in step ST2 (step ST3).

Next, the image output unit 313 generates global model image data and outputs the generated global model image data to the first external evaluating device 400 (step ST4). The first external evaluating device 400 displays an image of the global model on a display unit such as a display on the basis of the acquired data, and receives a determination result or a selection result by the user. The first external evaluating device 400 outputs data indicating a determination result or a selection result by the user to the model determining unit 314.

Next, the model determining unit 314 acquires data indicating a determination result or a selection result by the user, and determines whether or not the result indicates that any global model has been selected (step ST5). As a result, when the result indicates that no global model is selected (step ST5; No), the process returns to step ST1, and the explanatory variable acquiring unit 303 acquires a new first explanatory variable x1 from the user via the first external evaluating device 400. Hereinafter, steps ST2 to ST5 are repeated.

On the other hand, when the above result indicates that any of the global models has been selected (step ST5; Yes), the process proceeds to step ST6, and the filter processing unit 351 classifies (filters) the vibration data into data (Data A) that is regarded as varying and data (Data B) that is regarded as not varying (step ST6).

Next, the distribution calculating unit 361 calculates each of the probability distribution pA of Data A and the probability distribution pB of Data B for the first explanatory variable x1. Further, the distribution difference comparing unit 362 selects a range Ω in which pB|Ω−pA|Ω(Ω=[a, a+S], a is any value of the first explanatory variable x1) is maximized from the search width S (step ST7).

Next, the second variable selection processing unit 353 selects the second explanatory variable x2 that is an explanatory variable other than the first explanatory variable x1 and that can accurately separate Data A and Data B (step ST8).

Next, the region evaluating unit 363 generates a distribution diagram in which vibration data is displayed in a region determined by a combination of the first explanatory variable x1 and the second explanatory variable x2. Then, the model constructing unit 364 receives selection of a region made by the user on the basis of the distribution diagram (step ST9).

Next, the model constructing unit 364 constructs a local model using the vibration data and the control information data included in the region selected in step ST9 (step ST10).

Next, the prediction error calculating unit 365 calculates a prediction error of the local model, and the image output unit 366 generates image data indicating a prediction result and outputs the image data to the second external evaluating device 500. The second external evaluating device 500 displays an image indicating a prediction result on the display unit, and receives a determination result or a selection result by the user. The second external evaluating device 500 outputs data indicating a determination result or a selection result by the user to the model determining unit 367.

Next, the model determining unit 367 acquires the data indicating a determination result or a selection result by the user, and determines whether or not the result indicates that any local model has been selected (step ST11). As a result, when the result indicates that no local model is selected (step ST11; No), the model updating unit 312 instructs the user to select a new first explanatory variable x1 via the first external evaluating device 400. Thereafter, the process proceeds to step S21, and the explanatory variable acquiring unit 303 acquires a new first explanatory variable x1 from the user via the first external evaluating device 400. Hereinafter, steps ST2 to ST11 are repeated.

Note that, although not illustrated in the flowchart of FIG. 13, in a case where the above result indicates that no local model has been selected (step ST11; No), the model updating unit 312 may instruct the user to change the range of the first explanatory variable x1, such as narrowing the range of the first explanatory variable x1, via the first external evaluating device 400. When the model updating unit 312 instructs the user to change the range of the first explanatory variable x1, the process only needs to return to step ST2.

In addition, similarly, when the above result indicates that any local model is not selected (step ST11; No), the model updating unit 312 may instruct the user to re-input the search width or re-select the regions U1 to U3 via the first external evaluating device 400. In a case where the model updating unit 312 instructs the user to re-input the search width, the processing returns to step ST7, and in a case where the model updating unit instructs the user to re-select the regions U1 to U3, the process only needs to return to step ST9.

On the other hand, when the above result indicates that any one of the local models has been selected (step ST11; Yes), the process proceeds to step S32, and the model determining unit 367 causes the recording unit 100 to record data indicating the selected local model (step ST12). Further, the model determining unit 367 also records the control condition data in the recording unit 100.

With the above configuration, the learning device 300 according to the first embodiment can reduce the number of man-hours required for learning as compared with the related art when learning a model for detecting an abnormality of a target device by using data having variation collected from the target device.

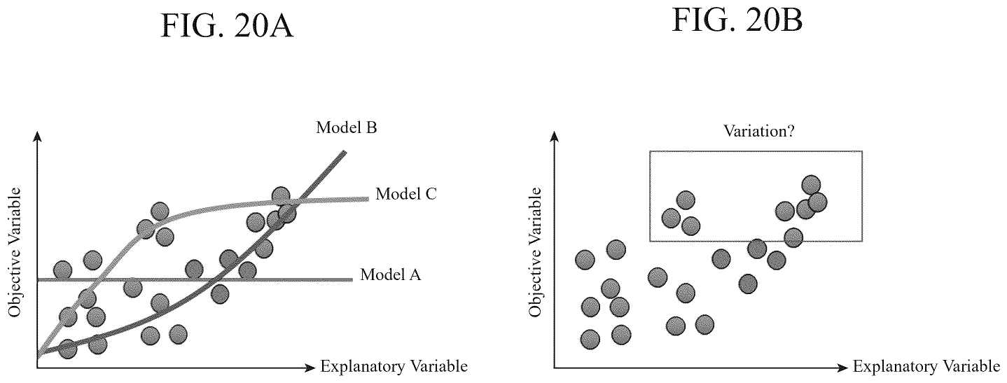

To supplement this point, for example, in a conventional device, normal data (training data) having variation is clustered so as to cover all patterns, but from a physical viewpoint, operating conditions of a target device suitable for abnormality detection are often limited. However, in the conventional device, it is difficult to perform learning using the normal data collected under the limited operating conditions, and as a result, there is a problem that the number of man-hours for learning the regression model increases. Further, in the conventional device, in a case where there are a large number of pieces of control information (parameters) for determining the operating condition, or in a case where each piece of control information has a continuous value, there are an infinite number of methods of condition division, and there is a problem that calculation cost is required. Furthermore, in the conventional device, even if some regression models can be constructed as illustrated in FIG. 20A, for example, by clustering normal data so as to cover all patterns, it is difficult to select an appropriate regression model from these regression models. Further, in the conventional device, it is assumed that the evaluation of the variation in the normal data varies depending on which regression model is selected. Therefore, in the conventional device, for example, as illustrated in FIG. 20B, it is also difficult to evaluate whether the normal data present in the square frame can be said to be truly data having variation.

In this regard, in the learning device 300 according to the first embodiment, as described above, first, the global model constructing unit 304 constructs a global learned model (global model) that has acquired validity from a physical viewpoint, then, the second variable selecting unit 360 selects the second explanatory variable x2 that can separate the target data regarded as varying from the training data, and the local model constructing unit 354 constructs a regression model (local model) applicable between the training data and the first explanatory variable x1 using the training data after the target data is separated on the basis of the second explanatory variable x2 and the first explanatory variable x1. As described above, in the learning device 300, by selecting the second explanatory variable x2 that can separate the target data regarded as varying from the training data, the possibility of finding a limited operating condition of the target device is increased, and the man-hours and the calculation cost required for learning can be reduced as compared with the conventional device. Further, in the learning device 300, since the target data regarded as varying can be separated from the training data, it is possible to construct a regression model with high inference accuracy in addition to facilitating selection of an appropriate regression model and evaluation of variation in training data, which are difficult in the conventional device.

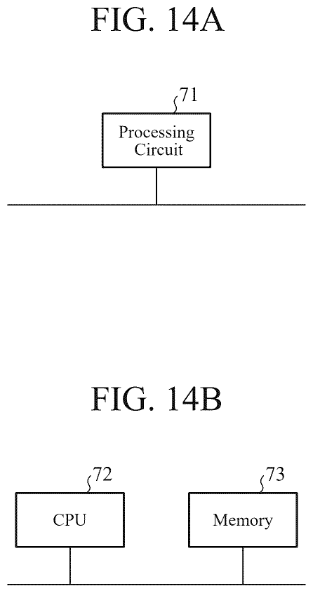

Next, a hardware configuration example of the learning device 300 according to the first embodiment will be described with reference to FIG. 14. The functions of the global learning unit 301 and the local learning unit 350 in the learning device 300 are implemented by a processing circuit. The processing circuit may be dedicated hardware as illustrated in FIG. 14A, or may be a central processing unit (CPU, which may also be referred to as a central processing device, a processing device, an arithmetic device, a microprocessor, a microcomputer, a processor, or a digital signal processor (DSP)) 72 that executes a program stored in a memory 73 as illustrated in FIG. 14B.

In a case where the processing circuit is dedicated hardware, the processing circuit 71 corresponds to, for example, a single circuit, a composite circuit, a programmed processor, a parallel programmed processor, an application specific integrated circuit (ASIC), a field programmable gate array (FPGA), or a combination thereof. The functions of respective units of the global learning unit 301 and the local learning unit 350 may be implemented by the processing circuit 71, or the functions of the respective units may be collectively implemented by the processing circuit 71.

When the processing circuit is the CPU 72, the functions of the global learning unit 301 and the local learning unit 350 are implemented by software, firmware, or a combination of software and firmware. The software and the firmware are described as programs and stored in the memory 73. The processing circuit implements the functions of the respective units by reading and executing the programs stored in the memory 73. That is, the learning device 300 includes a memory for storing a program that results in execution of each step illustrated in FIG. 13, for example, when executed by the processing circuit. Further, it can also be said that these programs cause a computer to execute the procedures and methods of the global learning unit 301 and the local learning unit 350. Here, the memory 73 corresponds to, for example, a nonvolatile or volatile semiconductor memory such as a random access memory (RAM), a read only memory (ROM), a flash memory, an erasable programmable ROM (EPROM), or an electrically EPROM (EEPROM), a magnetic disk, a flexible disk, an optical disk, a compact disk, a mini disk, or a digital versatile disc (DVD).

Note that some of the functions of the global learning unit 301 and the local learning unit 350 may be implemented by dedicated hardware, and some may be implemented by software or firmware. For example, the functions of the global learning unit 301 can be implemented by a processing circuit as dedicated hardware, and the functions of the local learning unit 350 can be implemented by the processing circuit reading and executing a program stored in the memory 73.

As described above, the processing circuit can implement the above-described functions by hardware, software, firmware, or a combination thereof.

### <State Inferring Device 600>

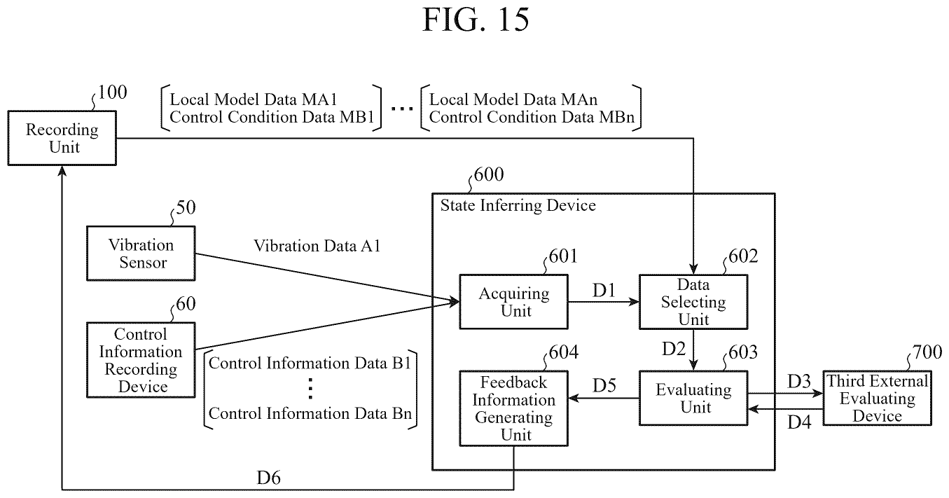

Next, the state inferring device 600 according to the first embodiment will be described. FIG. 15 is a diagram illustrating a configuration example of the state inferring device 600 according to the first embodiment. For example, as illustrated in FIG. 15, the state inferring device 600 includes an acquiring unit 601, a data selecting unit 602, an evaluating unit 603, and a feedback information generating unit 604.

The state inferring device 600 detects an abnormality of the target device by inferring the state of the target device using the local model indicated by the data (local model data) recorded in the recording unit 100 by the learning device 300. Note that, in the following description, the abnormality of the target device is assumed to be deterioration of the target device.

### (Acquiring Unit 601)

The acquiring unit 601 acquires vibration data A1 from the vibration sensor 50 attached to the target device. The vibration data A1 is data indicating a temporal change in the vibration amplitude value of the target device acquired from the target device by the vibration sensor 50 attached to the target device. Note that the vibration data A1 may be data indicating a temporal change in the feature amount of the vibration amplitude value. In this case, the feature amount of the vibration amplitude value only needs to be, for example, an RMS value of the vibration amplitude value. Note that, in the following description, a case where the vibration data is the RMS value of the vibration amplitude value will be described as an example.

Further, the acquiring unit 601 acquires pieces of control information data B1 to Bn from a control information recording device 60. Here, as illustrated in the second to fourth graphs from the top in FIG. 3 described above, the pieces of control information data B1 to Bn are data indicating the temporal change of the control information, and are data temporally synchronized with the vibration data. Further, n is the number of pieces of control information. Here, the control information is a parameter for determining an operating condition of the target device, and is, for example, a rotation speed, a current value of driving power of a rotary machine, or the like when the target device is the rotary machine. Note that the control information recording device 60 is a dedicated device for recording the pieces of control information data B1 to Bn.

The acquiring unit 601 outputs data obtained by collecting the acquired vibration data A1 and the pieces of control information data B1 to Bn to the data selecting unit 602 as data D1.

### (Data Selecting Unit 602)

The data selecting unit 602 refers to the recording unit 100 and acquires pieces of local model data MA1 to MAn and pieces of control condition data MB1 to MBn from the recording unit 100. Here, n is the number of local models, and the local model data and the control condition data have a one-to-one correspondence. Note that, here, n=1 is assumed for easy understanding of the description.

The data selecting unit 602 extracts vibration data and control information data satisfying a control condition indicated by the acquired control condition data MB1 from the vibration data and the control information data included in the data D1 described above, and outputs data in which the extracted data, the local model data MA1, and the control condition data MB1 are collected to the evaluating unit 603 as data D2.

### (Evaluating Unit 603)

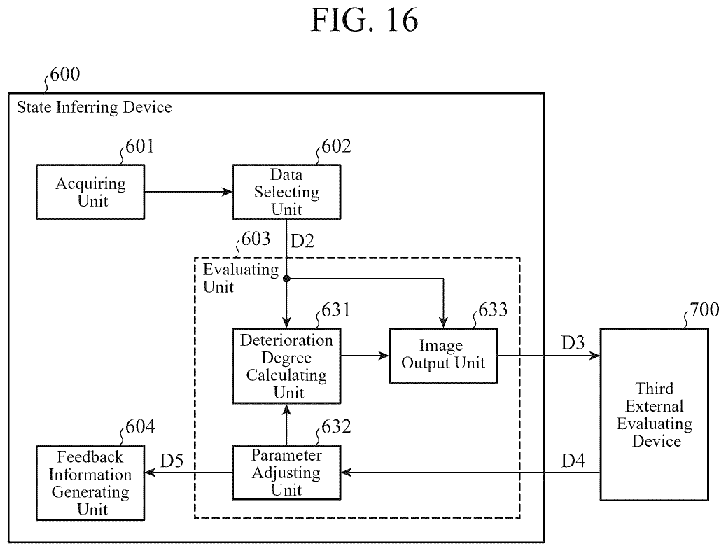

For example, as illustrated in FIG. 16, the evaluating unit 603 includes a deterioration degree calculating unit 631, a parameter adjusting unit 632, and an image output unit 633.

### (Deterioration Degree Calculating Unit 631)

The deterioration degree calculating unit 631 acquires the data D2 from the data selecting unit 602. The deterioration degree calculating unit 631 analyzes the acquired data D2 to calculate the deterioration degree of the target device. Specifically, for example, the deterioration degree calculating unit 631 inputs any value (for example, rotation speed=500) of the control information data B1 included in the data D2 to the local model indicated by the local model data MA1 included in the data D2. The local model outputs vibration data (for example, RMS value=1.5) corresponding to the input value on the basis of the input value.

Then, the deterioration degree calculating unit 631 compares the vibration data output from the local model with the vibration data corresponding to the any value included in the data D2, and calculates an error therebetween. Then, the deterioration degree calculating unit 631 calculates the deterioration degree of the target device by comparing the calculated error with a predetermined threshold. Note that the deterioration degree calculating unit 631 can calculate the deterioration degree using, for example, a mean absolute percentage error (MAPE), T2 hoteling, or the like. The deterioration degree calculating unit 631 outputs data indicating the calculated deterioration degree to the image output unit 633 as a state descriptor.

### (Image Output Unit 633)

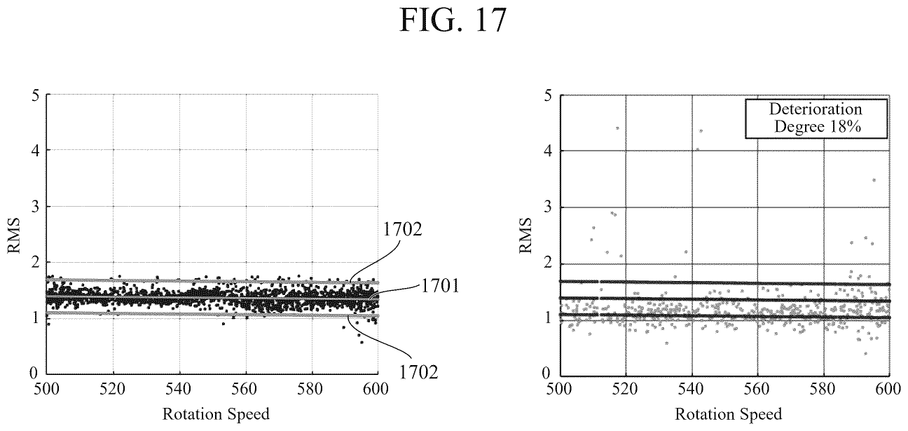

The image output unit 633 acquires the state descriptor from the deterioration degree calculating unit 631. Further, the image output unit 633 acquires the data D2 from the data selecting unit 602. Then, the image output unit 633 generates data indicating a comparison image as illustrated in FIG. 17, for example, using the acquired data. In FIG. 17, the left side is an image illustrating a distribution of vibration data (training data) used for constructing the local model, and the right side is an image illustrating a distribution of vibration data obtained by actually inputting the control information data B1 acquired from the target device into the local model. With such an image, the user can easily grasp how much the distribution of the vibration data obtained by inputting the control information data B1 actually acquired from the target device to the local model deviates from the distribution of the vibration data (training data) used when the local model is constructed. The image output unit 633 outputs data indicating the generated comparison image to the third external evaluating device 700.

The third external evaluating device 700 acquires data indicating the comparison image from the image output unit 633. The third external evaluating device 700 displays a comparison image as illustrated in FIG. 17 on a display unit (not illustrated) on the basis of the acquired data. The user checks the comparison image displayed on the display unit, and performs parameter adjustment using the third external evaluating device 700 as necessary.

For example, as illustrated in FIG. 17, there may be a slight difference between both distributions due to an accidental cause. In this case, the deterioration degree may change due to a slight difference caused by an accidental cause unrelated to the deterioration. For example, in the example of FIG. 17, although the target device is not actually deteriorated so much, “deterioration degree 18%” is calculated. Thus, the user performs parameter adjustment to adjust such a slight difference.

For example, the user adjusts the position of a prediction line 1701 obtained by the local model illustrated on the left side of FIG. 17 and the position of a line 1702 indicating the boundary of the confidence interval set for the prediction line 1701. In this case, for example, the user visually checks the difference between the left and right distribution diagrams in FIG. 17 and adjusts the position of each line, or calculates the difference between the average values of the left and right vibration data and adjusts the position of each line.

Alternatively, the user adjusts the interval between the prediction line 1701 obtained by the local model illustrated on the left side of FIG. 17 and the line 1702 indicating the boundary of the confidence interval set for the prediction line 1701. Also in this case, for example, the user adjusts the interval by visually checking the variation ratio of the vibration data in the left and right distribution diagrams of FIG. 17 or by taking a magnification of a standard deviation value of the left and right vibration data.

The third external evaluating device 700 outputs data indicating the adjustment content input by the user to the parameter adjusting unit 632 as an adjustment descriptor D4. The adjustment descriptor D4 includes regression model data to be adjusted, control condition data, data necessary for model adjustment (specifically, a correction value of a regression coefficient), and the like. In particular, data necessary for model adjustment is also referred to as a parameter adjuster. Further, the adjustment descriptor D4 also includes a determinator that is input by the user and determines whether or not to output the adjustment descriptor D4 to the feedback information generating unit 604. For example, when the determinator is 1, it indicates that the adjustment descriptor D4 is output to the feedback information generating unit 604, and when the determinator is 0, it indicates that the adjustment descriptor D4 is not output to the feedback information generating unit 604.

Note that the parameter adjuster in the adjustment descriptor D4 is input by the user, for example, in a case where the user adjusts the parameter adjuster by visually observing the left and right distribution diagrams in FIG. 17, but in other cases (for example, in a case where a difference between the average values of the left and right vibration data is calculated to adjust the position of each line), the parameter adjusting unit 632 can automatically calculate the parameter adjuster, for example, and thus the parameter adjuster does not necessarily need to be input by the user.

### (Parameter Adjusting Unit 632)

The parameter adjusting unit 632 acquires the adjustment descriptor D4 from the third external evaluating device 700. The parameter adjusting unit 632 outputs the acquired adjustment descriptor D4 to the deterioration degree calculating unit 631, and instructs the deterioration degree calculating unit 631 to adjust the local model on the basis of the adjustment descriptor D4. In response to this instruction, the deterioration degree calculating unit 631 adjusts the local model and calculates the deterioration degree again by the above procedure using the adjusted local model. Further, the deterioration degree calculating unit 631 outputs data indicating the deterioration degree calculated again to the image output unit 633 as a state descriptor. Hereinafter, the image output unit 633, the third external evaluating device 700, and the parameter adjusting unit 632 repeat the above-described processing.

Note that, when the parameter adjusting unit 632 stops acquiring the adjustment descriptor D4 from the third external evaluating device 700 in the above repetition, the parameter adjusting unit instructs the image output unit 633 to display a final calculation result of the deterioration degree on the display unit of the third external evaluating device 700.

Further, the parameter adjusting unit 632 checks the content of the determinator included in the acquired adjustment descriptor D4. In a case where the content of the determinator indicates that the adjustment descriptor D4 is output to the feedback information generating unit 604, the parameter adjusting unit 632 outputs the adjustment descriptor D4 to the feedback information generating unit 604 as data D5. On the other hand, in a case where the content of the determinator indicates that the adjustment descriptor D4 is not to be output to the feedback information generating unit 604, the parameter adjusting unit 632 does not output the adjustment descriptor D4 to the feedback information generating unit 604.

### (Feedback Information Generating Unit 604)

The feedback information generating unit 604 acquires the data D5 from the parameter adjusting unit 632. The feedback information generating unit 604 generates feedback information D6 on the basis of the acquired data D5, and causes the recording unit 100 to record the generated feedback information D6. The feedback information D6 includes regression model data to be adjusted, control condition data, data necessary for model adjustment (specifically, a correction value of a regression coefficient), and the like, almost similarly to the adjustment descriptor D4. Note that the feedback information generating unit 604 causes the recording unit 100 to record the feedback information D6 as information different from the local model data MA1 and the control condition data MB1 already recorded in the recording unit 100.

Thereafter, the user may appropriately reflect the feedback information D6 recorded in the recording unit 100 in the local model data MA1 and the control condition data MB1. Thus, the local model data MA1 and the control condition data MB1 are updated on the basis of the feedback information D6, and it is possible to reduce the possibility of a detection error caused by a difference (for example, a difference due to the above-described accidental cause) that cannot be known at the time of constructing the second regression model between the data actually acquired from the target device and the training data used when the second regression model is constructed.

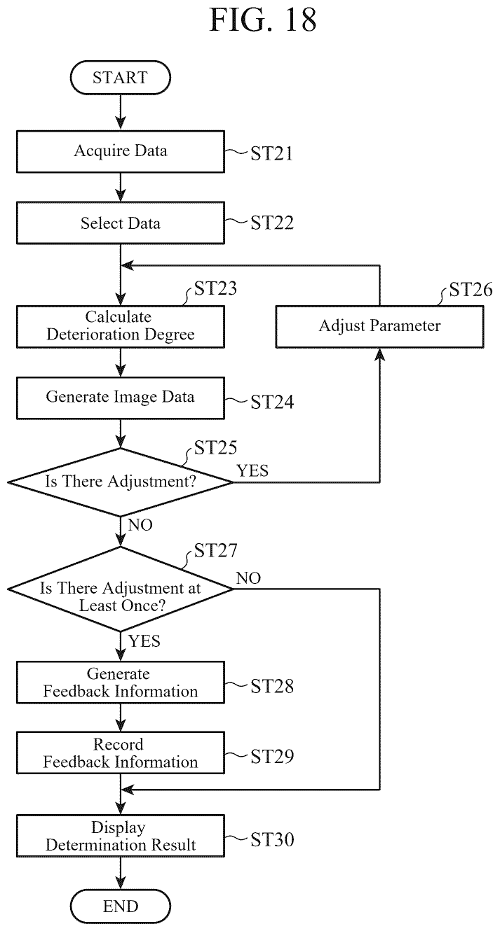

Next, an operation example of the state inferring device 600 according to the first embodiment will be described with reference to a flowchart illustrated in FIG. 18.

First, the acquiring unit 601 receives vibration data from the vibration sensor 50 attached to the target device. Further, the acquiring unit 601 also acquires control information data from the control information recording device 60 (step ST21).

Next, the data selecting unit 602 acquires the local model data and the control condition data from the recording unit 100, and extracts the vibration data and the control information data satisfying the control condition indicated by the acquired control condition data from the vibration data and the control information data acquired in step ST21 (step ST22).

Next, the deterioration degree calculating unit 631 calculates the deterioration degree of the target device using the data extracted in step ST22 (step ST23).

Next, the image output unit 633 generates data indicating a comparison image as illustrated in FIG. 17, for example, by using the calculation result in step ST23 (step ST24). The image output unit 633 outputs data indicating the generated comparison image to the third external evaluating device 700.

Next, the parameter adjusting unit 632 determines whether or not the adjustment descriptor D4 has been acquired from the third external evaluating device 700 (step ST25). As a result, when the parameter adjusting unit 632 determines that the adjustment descriptor D4 has been acquired from the third external evaluating device 700 (step ST25; Yes), the parameter adjusting unit 632 outputs the adjustment descriptor D4 to the deterioration degree calculating unit 631, and instructs the deterioration degree calculating unit 631 to adjust the local model on the basis of the adjustment descriptor D4. The deterioration degree calculating unit 631 adjusts the local model on the basis of the adjustment descriptor D4 (step ST26). Thereafter, the process returns to step ST23.

On the other hand, when the parameter adjusting unit 632 determines that the adjustment descriptor D4 has not been acquired from the third external evaluating device 700 (step ST25; No), the process proceeds to step ST26.

In step ST26, the parameter adjusting unit 632 determines whether or not the adjustment descriptor D4 has been acquired at least once from the third external evaluating device 700 so far (step ST26). As a result, when the parameter adjusting unit 632 determines that the adjustment descriptor D4 has not been acquired from the third external evaluating device 700 at least once (step ST26; No), the process proceeds to step ST29.

On the other hand, when the parameter adjusting unit 632 determines that the adjustment descriptor D4 has been acquired from the third external evaluating device 700 at least once (step ST26; Yes), the content of the determinator included in the adjustment descriptor D4 acquired last is checked. Then, when the content of the determinator indicates that the adjustment descriptor D4 is output to the feedback information generating unit 604, the adjustment descriptor D4 acquired last is output to the feedback information generating unit 604 as data D5.

The feedback information generating unit 604 generates the feedback information D6 on the basis of the data D5 acquired from the parameter adjusting unit 632 (step ST27), and causes the recording unit 100 to record the generated feedback information D6 (step ST28). Thereafter, the process proceeds to step ST29.

In step ST29, the image output unit 633 generates data indicating a final calculation result of the deterioration degree of the target device, and outputs the generated data to the third external evaluating device 700 to display the final calculation result of the deterioration degree of the target device on the display unit (step ST29).

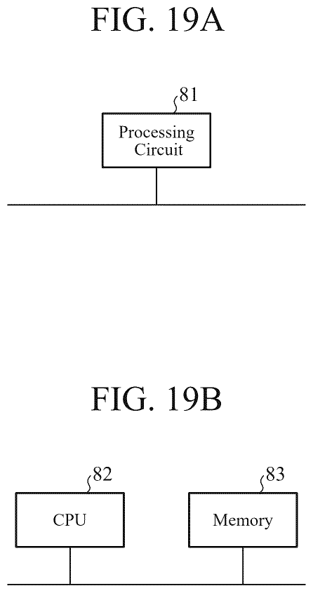

Next, a hardware configuration example of the state inferring device 600 according to the first embodiment will be described with reference to FIG. 19. The functions of the acquiring unit 601, the data selecting unit 602, the evaluating unit 603, and the feedback information generating unit 604 in the state inferring device 600 are implemented by a processing circuit. The processing circuit may be dedicated hardware as illustrated in FIG. 19A, or may be a central processing unit (CPU, which may also be referred to as a central processing device, a processing device, an arithmetic device, a microprocessor, a microcomputer, a processor, or a digital signal processor (DSP)) 82 that executes a program stored in a memory 83 as illustrated in FIG. 19B.

In a case where the processing circuit is dedicated hardware, a processing circuit 81 corresponds to, for example, a single circuit, a composite circuit, a programmed processor, a parallel programmed processor, an application specific integrated circuit (ASIC), a field programmable gate array (FPGA), or a combination thereof. The functions of the acquiring unit 601, the data selecting unit 602, the evaluating unit 603, and the feedback information generating unit 604 may be implemented by the processing circuit 81, or the functions of the respective units may be collectively implemented by the processing circuit 81.

When the processing circuit is the CPU 82, the functions of the acquiring unit 601, the data selecting unit 602, the evaluating unit 603, and the feedback information generating unit 604 are implemented by software, firmware, or a combination of software and firmware. The software and the firmware are described as programs and stored in the memory 83. The processing circuit implements the functions of the respective units by reading and executing the programs stored in the memory 83. That is, the state inferring device 600 includes a memory for storing a program that results in execution of each step illustrated in FIG. 18, for example, when executed by the processing circuit. Further, it can also be said that these programs cause a computer to execute the procedures and methods of the acquiring unit 601, the data selecting unit 602, the evaluating unit 603, and the feedback information generating unit 604. Here, the memory 83 corresponds to, for example, a nonvolatile or volatile semiconductor memory such as a random access memory (RAM), a read only memory (ROM), a flash memory, an erasable programmable ROM (EPROM), or an electrically EPROM (EEPROM), a magnetic disk, a flexible disk, an optical disk, a compact disk, a mini disk, or a digital versatile disc (DVD).

Note that some of the functions of the acquiring unit 601, the data selecting unit 602, the evaluating unit 603, and the feedback information generating unit 604 may be implemented by dedicated hardware, and some may be implemented by software or firmware. For example, the functions of the acquiring unit 601 can be implemented by a processing circuit as dedicated hardware, and the functions of the data selecting unit 602, the evaluating unit 603, and the feedback information generating unit 604 can be implemented by the processing circuit reading and executing programs stored in the memory 83.

As described above, the processing circuit can implement the above-described functions by hardware, software, firmware, or a combination thereof.

As described above, according to the first embodiment, the learning device 300 includes: the global model constructing unit 304 to construct, on the basis of training data explainable by a plurality of explanatory variables and a first explanatory variable x1 that is an explanatory variable designated from the outside and is one of the plurality of explanatory variables, the first regression model (global model) applicable to the training data and the first explanatory variable x1; the second variable selecting unit 360 to select a second explanatory variable x2 from among the plurality of explanatory variables, and to select, from the training data, the second explanatory variable x2 with which target data regarded as varying on the basis of the first regression model constructed by the global model constructing unit 304 is separable from the training data; and the local model constructing unit 354 to construct, using training data after the target data is separated on the basis of the second explanatory variable x2 selected by the second variable selecting unit 360 and the first explanatory variable x1, a second regression model (local model) applicable to the training data and the first explanatory variable x1. Thus, the learning device 300 according to the first embodiment can reduce the number of man-hours required for learning as compared with the related art when learning a model for detecting an abnormality of a target device by using data having variation collected from the target device.

Further, the second variable selecting unit 360 further includes: the filter processing unit 351 to classify the training data into the target data (Data A) that is regarded as varying and non-target data (Data B) that is regarded as not varying on the basis of the first regression model constructed by the global model constructing unit 304; the range selecting unit 352 to select a predetermined range from among ranges capable of being taken by the first explanatory variable x1 on the basis of the target data and the non-target data classified by the filter processing unit 351; and the second variable selection processing unit 353 to select the second explanatory variable x2 using training data included in the predetermined range selected by the range selecting unit 352. Thus, the learning device 300 according to the first embodiment can appropriately select the second explanatory variable x2 on the basis of the first regression model and the training data.

Further, the filter processing unit 351 sets, as the target data, training data located outside a predetermined confidence interval that is centered on a prediction line and is set for the prediction line obtained on the basis of the first regression model constructed by the global model constructing unit 304, and sets, as the non-target data, training data located inside the predetermined confidence interval centered on the prediction line. Thus, the learning device 300 according to the first embodiment can easily classify the training data into the target data (Data A) that is regarded as varying and the non-target data (Data B) that is regarded as not varying.

Further, the range selecting unit 352 includes: the distribution calculating unit 361 to calculate, for each of the target data and the non-target data, a probability distribution indicating how frequently the target data and the non-target data classified by the filter processing unit 351 appear with respect to the first explanatory variable x1; and the distribution difference comparing unit 362 to calculate a difference between the probability distribution of the target data calculated by the distribution calculating unit 361 and the probability distribution of the non-target data calculated by the distribution calculating unit 361, and select a range of the first explanatory variable x1 in which the calculated difference is equal to or more than a predetermined value as the predetermined range. Thus, the learning device 300 according to the first embodiment can easily select the predetermined range of the first explanatory variable x1 used to select the second explanatory variable x2.

Further, the distribution difference comparing unit 362 selects the predetermined range from the search width S received from the outside, the search width S indicating a range in which a ratio of presence of the non-target data is assumed to be relatively high in the range of the first explanatory variable x1. Thus, the learning device 300 according to the first embodiment can appropriately select the predetermined range of the first explanatory variable x1 on the basis of the search width S received from the outside.

Further, the second variable selection processing unit 353 generates a probability distribution indicating how frequently the training data included in the predetermined range selected by the range selecting unit 352 appears with respect to a certain explanatory variable, and when a range of the first explanatory variable x1 in which a ratio of the target data with respect to the number of pieces of the training data in the generated probability distribution is equal to or more than a predetermined value is set as a first range Y, and a range of the first explanatory variable x1 excluding the first range Y is set as a second range X, selects an explanatory variable in which a ratio of the non-target data with respect to the training data included in the second range X is equal to or more than a predetermined value as the second explanatory variable x2. Thus, the learning device 300 according to the first embodiment can appropriately and efficiently select the second explanatory variable x2.

Further, the local model constructing unit 354 includes: the region evaluating unit 363 to generate data indicating an image indicating a region in which the target data has appeared and a region in which the non-target data has appeared in a region determined by a combination of the second explanatory variable x2 selected by the second variable selecting unit 360 and the first explanatory variable x1; and the model constructing unit 364 to receive a region designated from the outside on the basis of the image indicated by the data generated by the region evaluating unit 363 in a region determined by a combination of the first explanatory variable x1 and the second explanatory variable x2, and construct the second regression model using training data included in the received region. Thus, the learning device 300 according to the first embodiment can construct the second regression model reflecting the intention of the outside (for example, the user).

Further, the learning device 300 includes: the model evaluating unit 305 to receive evaluation from the outside for a first regression model constructed by the global model constructing unit 304; and the model evaluating unit 355 to receive evaluation from the outside for a second regression model constructed by the local model constructing unit 354. Thus, the learning device 300 according to the first embodiment can obtain evaluation from the outside (for example, the user) for the first regression model and the second regression model.

Further, the global model constructing unit 304 includes the model updating unit 312 to reconstruct, when the evaluation received by the model evaluating unit 355 indicates that a desired second regression model is not present, a first regression model applicable to the training data and a new first explanatory variable x1 on the basis of the training data and the new first explanatory variable x1 that is a new first explanatory variable x1 designated from the outside and is one of the plurality of explanatory variables. Thus, in a case where the desired second regression model is not constructed, the learning device 300 according to the first embodiment can reconstruct from the first regression model.

Further, according to the first embodiment, the state inferring device 600 infers a state of a target device using a second regression model constructed by the local model constructing unit 354 of the learning device 300 and data corresponding to training data and data corresponding to a first explanatory variable x1 acquired from the target device, the learning device 300 including: the global model constructing unit 304 to construct, on the basis of the training data explainable by a plurality of explanatory variables and the first explanatory variable x1 that is an explanatory variable designated from the outside and is one of the plurality of explanatory variables, the first regression model (global model) applicable to the training data and the first explanatory variable x1; the second variable selecting unit 360 to select a second explanatory variable x2 from among the plurality of explanatory variables, and to select, from the training data, the second explanatory variable x2 with which target data regarded as varying on the basis of the first regression model constructed by the global model constructing unit 304 is separable from the training data; and the local model constructing unit 354 to construct, using training data after the target data is separated on the basis of the second explanatory variable x2 selected by the second variable selecting unit 360 and the first explanatory variable x1, a second regression model (local model) applicable to the training data and the first explanatory variable x1. Thus, the state inferring device 600 according to the first embodiment can accurately infer the state of the target device.

Further, the state inferring device 600 includes the feedback information generating unit 604 to correct a regression coefficient in the second regression model on the basis of a correction value that is received from the outside and is a correction value to correct the regression coefficient in the second regression model. Thus, the state inferring device 600 according to the first embodiment can reduce the possibility of a detection error caused by a difference that is not known at the time of construction between the data actually acquired from the target device and the training data used when the second regression model is constructed.

Further, according to the first embodiment, the state monitoring system 1000 includes: the learning device 300 including: the global model constructing unit 304 to construct, on the basis of training data explainable by a plurality of explanatory variables and a first explanatory variable x1 that is an explanatory variable designated from the outside and is one of the plurality of explanatory variables, a first regression model (global model) applicable to the training data and the first explanatory variable x1; the second variable selecting unit 360 to select a second explanatory variable x2 from among the plurality of explanatory variables, and to select, from the training data, a second explanatory variable x2 with which target data regarded as varying on the basis of the first regression model constructed by the global model constructing unit 304 is separable from the training data; and the local model constructing unit 354 to construct, using training data after the target data is separated on the basis of the second explanatory variable x2 selected by the second variable selecting unit 360 and the first explanatory variable x1, a second regression model (local model) applicable between the training data and the first explanatory variable x1; and the state inferring device 600 to infer a state of a target device using the second regression model constructed by the local model constructing unit 354 and data corresponding to the training data and data corresponding to the first explanatory variable x1 acquired from the target device. Thus, when learning a model for detecting an abnormality of a target device using data having variation collected from the target device, the state monitoring system 1000 according to the first embodiment can reduce the number of man-hours required for learning as compared with the related art and can accurately infer the state of the target device using the model.

Finally, a preferred application example of the learning device 300 and the state inferring device 600 according to the first embodiment will be described. The learning device 300 according to the first embodiment is suitable for use in, for example, a monitoring system for an electric motor mounted on a railway vehicle. In the electric motor mounted on the railway vehicle, there are many pieces of control information such as brake information, rotation speed information, current information, and voltage information of the electric motor simultaneously with the vibration data. In a case of constructing a system that monitors vibration data reflecting the state of the electric motor under the control information, first, a model (global model) with the rotation speed as an explanatory variable is constructed by the global model constructing unit 304 in order to utilize user's knowledge (for example, it has been found that the vibration and the rotation speed are closely related, and a high-frequency vibration feature easily appears at a low speed). Next, in order to improve the accuracy of the model, the model (local model) is constructed through designation of the region of the rotation speed by the user and narrowing of conditions utilizing other control information that can exclude data deviating from the global model. Thus, in the monitoring system, it is possible to take in the knowledge of the user for model construction, reduce the processes of model construction and evaluation using the explanatory variables and conditions considered to be unnecessary for deterioration detection, and efficiently construct the model.

Further, similarly to the learning device 300, the state inferring device 600 according to the first embodiment is also suitable for use in, for example, a monitoring system of an electric motor mounted on a railway vehicle. For example, an alarm device is further provided in the state inferring device 600 according to the first embodiment, and an alarm is output to the user of the monitoring system when the state inferring device 600 determines that the target device is not the same object as the object set as the monitoring target on the basis of vibration data acquired from the vibration sensor 50 attached to the target device. In this manner, the state inferring device 600 according to the first embodiment is applicable to a monitoring system.

Further, similarly to the learning device 300 and the state inferring device 600, the state monitoring system 1000 according to the first embodiment is suitable for use in, for example, a monitoring system of an electric motor mounted on a railway vehicle.

Note that, in the present disclosure, any component of the embodiment can be modified, or any component of the embodiment can be omitted. For example, in the above description, the case where the training data as the objective variable is vibration data and the explanatory variable for describing the objective variable is control information data has been described as an example. However, the training data and the explanatory variable as the objective variable are not limited to the above example, and any type of data may be used as long as the explanatory variable explains the objective variable.

Further, in the above description, an example in which the recording unit 100 is provided separately from the learning device 300 and the state inferring device 600 has been described. However, the recording unit 100 is not limited thereto, and may be built in any one of the learning device 300 and the state inferring device 600, for example.

Alternatively, the recording unit 100 may be incorporated in any one of the first external evaluating device 400, the second external evaluating device 500, and the third external evaluating device 700.

Further, in the above description, an example has been described in which the first external evaluating device 400, the second external evaluating device 500, and the third external evaluating device 700 are separately provided. However, the individual devices are not limited thereto, and the functions of the respective devices may be integrated into any one device, or the functions of any two devices may be integrated into one device.

### REFERENCE SIGNS LIST

50: vibration sensor, 60: control information recording device, 71: processing circuit, 72: CPU, 73: memory, 81: processing circuit, 82: CPU, 83: memory, 100: recording unit, 200: training data recording unit, 300: learning device, 301: global learning unit, 302: data extracting unit, 303: explanatory variable acquiring unit, 304: global model constructing unit, 305: model evaluating unit (first model evaluating unit), 311: model constructing unit, 312: model updating unit, 313: image output unit, 314: model determining unit, 350: local learning unit, 351: filter processing unit, 352: range selecting unit, 353: second variable selection processing unit (variable selection processing unit), 354: local model constructing unit, 355: model evaluating unit (second model evaluating unit), 360: second variable selecting unit (variable selecting unit), 361: distribution calculating unit, 362: distribution difference comparing unit, 363: region evaluating unit, 364: model constructing unit, 365: prediction error calculating unit, 366: image output unit, 367: model determining unit, 390: intermediate recording unit, 400: first external evaluating device, 500: second external evaluating device, 501: prediction line, 502: line indicating boundary of confidence interval, 600: state inferring device, 601: acquiring unit, 602: data selecting unit, 603: evaluating unit, 604: feedback information generating unit, 631: deterioration degree calculating unit, 632: parameter adjusting unit, 633: image output unit, 700: third external evaluating device, 1000: state monitoring system, 1701: prediction line, 1702: line indicating boundary of confidence interval, A1: vibration data, B1: control information data, 210: vibration DB, 220: control information DB, U1: region, U2: region, U3: region

1. A learning device comprising:
processing circuitry configured to
construct, on a basis of training data explainable by a plurality of explanatory variables and a first explanatory variable that is an explanatory variable designated from an outside and is one of the plurality of explanatory variables, a first regression model applicable to the training data and the first explanatory variable;
select a second explanatory variable from among the plurality of explanatory variables, and to select, from the training data, a second explanatory variable with which target data regarded as varying on a basis of the constructed first regression model is separable from the training data; and
construct, using training data after the target data is separated on a basis of the selected second explanatory variable and the first explanatory variable, a second regression model applicable to the training data and the first explanatory variable.

2. The learning device according to claim 1, wherein
the processing circuitry is further configured to
classify the training data into the target data that is regarded as varying and non-target data that is regarded as not varying on a basis of the constructed first regression model,
select a predetermined range from among ranges capable of being taken by the first explanatory variable on a basis of the classified target data and the non-target data, and
select the second explanatory variable using training data included in the selected predetermined range.

3. The learning device according to claim 2, wherein
the processing circuitry is further configured to
set, as the target data, training data located outside a predetermined confidence interval that is centered on a prediction line and is set for the prediction line obtained on a basis of the constructed first regression model, and set, as the non-target data, training data located inside the predetermined confidence interval centered on the prediction line.

4. The learning device according to claim 2, wherein
the processing circuitry is further configured to
calculate, for each of the target data and the non-target data, a probability distribution indicating how frequently the classified target data and the non-target data appear with respect to the first explanatory variable, and
calculate a difference between the calculated probability distribution of the target data and the calculated probability distribution of the non-target data, and select a range of the first explanatory variable in which the calculated difference is equal to or more than a predetermined value as the predetermined range.

5. The learning device according to claim 4, wherein
the processing circuitry is further configured to
select the predetermined range from a search width received from an outside, the search width indicating a range in which a ratio of presence of the non-target data is assumed to be relatively high in the range of the first explanatory variable.

6. The learning device according to claim 2, wherein
the processing circuitry is further configured to
generate a probability distribution indicating how frequently the training data included in the selected predetermined range appears with respect to a certain explanatory variable, and when a range of the first explanatory variable in which a ratio of the target data with respect to a number of pieces of the training data in the generated probability distribution is equal to or more than a predetermined value is set as a first range, and a range of the first explanatory variable excluding the first range is set as a second range,
selects an explanatory variable in which a ratio of the non-target data with respect to the training data included in the second range is equal to or more than a predetermined value as the second explanatory variable.

7. The learning device according to claim 1, wherein
the processing circuitry is further configured to
generate data indicating an image indicating a region in which the target data regarded as varying has appeared and a region in which non-target data regarded as not varying has appeared in a region determined by a combination of the selected second explanatory variable and the first explanatory variable, and
receive a region designated from an outside on a basis of the image indicated by the generated data in a region determined by a combination of the first explanatory variable and the second explanatory variable, and construct the second regression model using training data included in the received region.

8. The learning device according to claim 1,
wherein the processing circuitry is further configured to
receive evaluation from an outside for the constructed first regression model; and
receive evaluation from an outside for the constructed second regression model.

9. The learning device according to claim 8, wherein
the processing circuitry is further configured to
reconstruct, when the received evaluation indicates that a desired second regression model is not present, a first regression model applicable to the training data and a new first explanatory variable on a basis of the training data and the new first explanatory variable that is a new first explanatory variable designated from an outside and is one of the plurality of explanatory variables.

10. A state inferring device to infer a state of a target device using a second regression model having been constructed by a learning device and data corresponding to training data and data corresponding to a first explanatory variable acquired from the target device, the learning device including
processing circuitry configured to
construct, on a basis of the training data explainable by a plurality of explanatory variables and the first explanatory variable that is an explanatory variable designated from an outside and is one of the plurality of explanatory variables, a first regression model applicable to the training data and the first explanatory variable,
select a second explanatory variable from among the plurality of explanatory variables, and to select, from the training data, a second explanatory variable with which target data regarded as varying on a basis of the constructed first regression model is separable from the training data, and
construct, using training data after the target data is separated on a basis of the selected second explanatory and the first explanatory variable, a second regression model applicable to the training data and the first explanatory variable.

11. The state inferring device according to claim 10,
wherein the processing circuitry is further configured to correct a regression coefficient in the second regression model on a basis of a correction value for correcting the regression coefficient in the second regression model, the correction value being received from an outside.

12. A state monitoring system comprising:
a learning device including:
processing circuitry configured to:
construct, on a basis of training data explainable by a plurality of explanatory variables and a first explanatory variable that is an explanatory variable designated from an outside and is one of the plurality of explanatory variables, a first regression model applicable to the training data and the first explanatory variable,
select a second explanatory variable from among the plurality of explanatory variables, and to select, from the training data, a second explanatory variable with which target data regarded as varying on a basis of the constructed first regression model is separable from the training data, and
construct, using training data after the target data is separated on a basis of the selected second explanatory variable and the first explanatory variable, a second regression model applicable between the training data and the first explanatory variable; and
a state inferring device to infer a state of a target device using the constructed second regression model and data corresponding to the training data and data corresponding to the first explanatory variable acquired from the target device.
